(19) United States
(12) Patent Application Publication
(10) Pub. No.: US 2016/0307272 A1
(43) Pub. Date: Oct. 20, 2016

(54) SYSTEM FOR REDUCING COMPUTATIONAL COSTS ASSOCIATED WITH PREDICTING DEMAND FOR PRODUCTS

(71) Applicant: Bank of America Corporation, Charlotte, NC (US)

(72) Inventor: Jason Thalken, Austin, TX (US)

(21) Appl. No.: 14/686,571

(22) Filed: Apr. 14, 2015

(51) Int. Cl. G06Q 40/06

(52) U.S. Cl. CPC G06Q 40/06

(57) ABSTRACT

Disclosed is a system for reducing computational costs associated with predicting demand for products. The system typically includes a network comprising a processor and a memory storing a pricing database, a prediction rules module, a server, and a dynamic cannibalization module. The system identifies a first financial product and a plurality of competing financial products, groups the first financial product with one or more of the competing financial products based on business constraints and cannibalization analysis, and then determines an ideal price point for the first financial product based on the group of competing financial products. The invention retains the accuracy of an exhaustive system while significantly reducing the computational costs associated with such an exhaustive system.

### FIELD OF THE INVENTION

The present invention embraces a system for reducing computational costs associated with predicting demand for certain products. The system typically includes a network comprising a processor and a memory storing a pricing database, a prediction rules module, a server, and a dynamic cannibalization module. The invention retains the accuracy of an exhaustive system while significantly reducing the computational costs associated with such an exhaustive system.

### BACKGROUND

Financial institutions typically use product-level elasticity models to predict how a price change (e.g., an interest rate change) of a financial product (e.g., a loan product, a mortgage, and the like) will affect the demand for that loan product. These product-level elasticity models are typically build using regression modeling of historical data to try to predict how a market will react to a financial product's price change.

High computational cost, including server time, personnel time, and monetary costs, are associated with running an exhaustive search on the product-level elasticity models. Accordingly, a need exists for an improved system for reducing the computational costs associated with predicting demand for financial products.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Methods, systems, and computer program products are described herein that provide for reducing computational costs associated with predicting demand for a first financial product. The system comprises a computing platform comprising one or more processing device and executable software stored in one or more electronic storage devices. The executable software code is configured to cause the one or more processing devices to take several actions, including the following: receive hypothetical customer profile data for a plurality of hypothetical customers; receive competing financial product data for a plurality of competing financial products, wherein the competing financial products comprise the first financial product and at least one other financial product that competes with the first financial product, and wherein the competing financial product data comprises at least a competing financial product, one or more financing types associated with each competing financial product, and one or more origination channels associated with each competing financial product; store hypothetical customer profile data in one or more network databases; store competing financial product data in one or more network databases; and store a plurality of rules for how hypothetical customers make a financial product decision in one or more network databases. The executable software code is also configured to cause the one or more processing devices to identify two or more segments for the competing financial products from the stored competing financial product data, wherein the segments comprise a first financial product segment, and wherein each of the segments comprises a combination of the following: (1) one of the competing financial products; (2) one of the one or more financing types associated with one of the competing financial products; and (3) one of the one or more origination channels associated with the one of the competing financial products. The executable software code is also configured to cause the one or more processing devices to execute a dynamic cannibalization module, wherein the dynamic cannibalization module is configured to cause the one or more processing devices to take several actions including the following: establish a minimum cannibalization tolerance level; pair the first financial product segment with one other segment of the segments, wherein the first segment comprises the first financial product; determine a minimum price point for each of the first financial product segment and the other segment; and determine a maximum price point for each of the first financial product segment and the other segment. Furthermore, the dynamic cannibalization module is further configured to cause the one or more processing devices to calculate a first difference Δ1, wherein the first difference Δ1 is the difference between a first demand volume of the first financial product segment from when both of the first financial product segment and the other segment are at their maximum price points and a second demand volume of the first financial product segment from when both of the first financial product segment and the other segment are at their minimum price points; calculate a second difference Δ2, wherein the second difference Δ2 is the difference in a third demand volume of the first financial product segment from when the first financial product segment is at its maximum price point and the other segment is at its minimum price point, and a fourth demand volume of the first financial product segment from when the first financial product segment is at its minimum price point and the other segment is at its maximum price point; and calculate a cannibalization percentage Cper, wherein the cannibalization percentage Cper is the difference between the first difference Δ1 and the second difference Δ2, divided by a baseline volume Vbase. The cannibalization module may then determine if the cannibalization percentage is equal to or greater than the minimum cannibalization tolerance level; and if the cannibalization percentage is equal to or greater than the minimum cannibalization tolerance level, then the cannibalization module may then combine the first financial product segment and the other segment into a first segment group. The cannibalization module may then repeat the steps “pair the first financial product segment . . . ” through “combine the first financial product segment and the other segment . . . ” for all other segments of the segments. Finally, the executable software code is also configured to cause the one or more processing devices to determine an ideal price point for the first financial product segment based on the first segment group.

In some embodiments, the executable software code is further configured to cause the one or more processing devices to determine a plurality of available price points for the first financial product segment; select a first price point for the first financial product from the plurality of available price points; determine a demand volume of the first financial product segment at the selected price point, wherein the demand volume of the first financial product segment is calculated based on an exhaustive algorithm that analyzes the demand volume of the first financial product segment for each combination of a plurality of price points for the one or more segments of the segment group; store the determined demand volume of the first financial product segment at the selected price point; repeat steps from “select a first price point . . . ” to “store the calculated demand volume . . . ” for each price point of the plurality of available price points for the first financial product segment; and finally determine an ideal price point for the first financial product segment based on the determined demand volume data. In some such embodiments, the executable software code is further configured to cause the one or more processing devices to apply the ideal price point to the first financial product segment.

In some embodiments, the executable software code is further configured to: monitor one or more network databases for changes to the hypothetical customer profile data and the competing financial product data; determine that one of the hypothetical customer profile data or the competing financial product data has changed; and update the one or more network databases associated with the hypothetical customer profile data or the competing financial product data with the changed data.

In some embodiments of the system, the first financial product is a loan refinancing product. In some embodiments of the system, the first financial product is a purchase loan product.

In some embodiments, a computer implemented method for reducing computational costs associated with predicting demand for a first financial product is provided. The computer implemented method comprises: providing a computing system within a distributive network for reducing computational costs associated with predicting demand for a first financial product, comprising a computer processing device and a non-transitory computer readable medium, where the computer readable medium comprises configured computer program instruction code, such that when said instruction code is operated by said computer processing device, said computer processing device performs the following operations: receiving hypothetical customer profile data for a plurality of hypothetical customers; receiving competing financial product data for a plurality of competing financial products, wherein the competing financial products comprise the first financial product and at least one other financial product that competes with the first financial product, and wherein the competing financial product data comprises at least a competing financial product, one or more financing types associated with each competing financial product, and one or more origination channels associated with each competing financial product; storing hypothetical customer profile data in one or more network databases; storing competing financial product data in one or more network databases; and storing a plurality of rules for how hypothetical customers make a financial product decision in one or more network databases. Additionally, the computer implemented method further comprises identifying two or more segments for the competing financial products from the stored competing financial product data, wherein the segments comprise a first financial product segment, and wherein each of the segments comprises a combination of the following: one of the competing financial products; one of the one or more financing types associated with the one of the competing financial products; and one of the one or more origination channels associated with the one of the competing financial products. Next, the computer implemented method comprises executing a dynamic cannibalization module, wherein the dynamic cannibalization module is configured to cause the one or more processing devices to: establish a minimum cannibalization tolerance level; pair the first financial product segment with one other segment of the segments, wherein the first segment comprises the first financial product; determine a minimum price point for each of the first financial product segment and the other segment; determine a maximum price point for each of the first financial product segment and the other segment; calculate a first difference Δ1, wherein the first difference Δ1 is the difference between a first demand volume of the first financial product segment from when both of the first financial product segment and the other segment are at their maximum price points and a second demand volume of the first financial product segment from when both of the first financial product segment and the other segment are at their minimum price points; calculate a second difference Δ2, wherein the second difference Δ2 is the difference in a third demand volume of the first financial product segment from when the first financial product segment is at its maximum price point and the other segment is at its minimum price point, and a fourth demand volume of the first financial product segment from when the first financial product segment is at its minimum price point and the other segment is at its maximum price point; calculate a cannibalization percentage Cper, wherein the cannibalization percentage Cper is the difference between the first difference Δ1 and the second difference Δ2, divided by a baseline volume Vbase; determine if the cannibalization percentage is equal to or greater than the minimum cannibalization tolerance level; and if the cannibalization percentage is equal to or greater than the minimum cannibalization tolerance level, then combine the first financial product segment and the other segment into a first segment group; and repeat the steps “pair the first financial product segment . . . ” through “combine the first financial product segment and the other segment . . . ” for all other segments of the segments. Finally, the computer implemented method comprises determining an ideal price point for the first financial product based on the first segment group.

In some embodiments, the computer implemented method further comprises determining a plurality of available price points for the first financial product segment; selecting a first price point for the first financial product from the plurality of available price points; determining a demand volume of the first financial product segment at the selected price point, wherein the demand volume of the first financial product segment is calculated based on an exhaustive algorithm that analyzes the demand volume of the first financial product segment for each combination of a plurality of price points for the one or more segments of the segment group; storing the determined demand volume of the first financial product segment at the selected price point; repeating steps from “select a first price point . . . ” to “store the calculated demand volume . . . ” for each price point of the plurality of available price points for the first financial product segment; and determining an ideal price point for the first financial product segment based on the determined demand volume data.

In some such embodiments, the computer implemented method may further comprise applying the ideal price point to the first financial product segment.

In some embodiments, the computer implemented method of claim further comprises: monitoring one or more network databases for changes to the hypothetical customer profile data and the competing financial product data; determining that one of the hypothetical customer profile data or the competing financial product data has changed; and updating the one or more network databases associated with the hypothetical customer profile data or the competing financial product data with the changed data.

In some embodiments of the computer implemented method, the first financial product is a loan refinancing product. In some embodiments of the computer implemented method, the first financial product is a purchase loan product.

In some embodiments of the invention, a computer program product for reducing computational costs associated with predicting demand for a first financial product is provided. The computer program product comprises a non-transitory computer readable medium comprising computer readable instructions, the instructions comprising instructions for: receiving hypothetical customer profile data for a plurality of hypothetical customers; receiving competing financial product data for a plurality of competing financial products, wherein the competing financial products comprise the first financial product and at least one other financial product that competes with the first financial product, and wherein the competing financial product data comprises at least a competing financial product, one or more financing types associated with each competing financial product, and one or more origination channels associated with each competing financial product; storing hypothetical customer profile data in one or more network databases; storing competing financial product data in one or more network databases; and storing a plurality of rules for how hypothetical customers make a financial product decision in one or more network databases. The computer program product also comprises computer readable instructions for identifying two or more segments for the competing financial products from the stored competing financial product data, wherein the segments comprise a first financial product segment, and wherein each of the segments comprises a combination of the following: one of the competing financial products; one of the one or more financing types associated with the one of the competing financial products; and one of the one or more origination channels associated with the one of the competing financial products. The computer program product further comprises executing a dynamic cannibalization module, wherein the dynamic cannibalization module is configured to cause the one or more processing devices to: establish a minimum cannibalization tolerance level; pair the first financial product segment with one other segment of the segments, wherein the first segment comprises the first financial product; determine a minimum price point for each of the first financial product segment and the other segment; determine a maximum price point for each of the first financial product segment and the other segment; calculate a first difference Δ1, wherein the first difference Δ1 is the difference between a first demand volume of the first financial product segment from when both of the first financial product segment and the other segment are at their maximum price points and a second demand volume of the first financial product segment from when both of the first financial product segment and the other segment are at their minimum price points; calculate a second difference Δ2, wherein the second difference Δ2 is the difference in a third demand volume of the first financial product segment from when the first financial product segment is at its maximum price point and the other segment is at its minimum price point, and a fourth demand volume of the first financial product segment from when the first financial product segment is at its minimum price point and the other segment is at its maximum price point; calculate a cannibalization percentage Cper, wherein the cannibalization percentage Cper is the difference between the first difference Δ1 and the second difference Δ2, divided by a baseline volume Vbase; determine if the cannibalization percentage is equal to or greater than the minimum cannibalization tolerance level; if the cannibalization percentage is equal to or greater than the minimum cannibalization tolerance level, then combine the first financial product segment and the other segment into a first segment group; and repeat the steps “pair the first financial product segment . . . ” through “combine the first financial product segment and the other segment . . . ” for all other segments of the segments. Finally, the computer program product comprises determining an ideal price point for the first financial product segment based on the first segment group.

In some embodiments of the invention, the computer program product further comprises determining a plurality of available price points for the first financial product segment; selecting a first price point for the first financial product from the plurality of available price points; determining a demand volume of the first financial product segment at the selected price point, wherein the demand volume of the first financial product segment is calculated based on an exhaustive algorithm that analyzes the demand volume of the first financial product segment for each combination of a plurality of price points for the one or more segments of the segment group; storing the determined demand volume of the first financial product segment at the selected price point; repeating steps from “select a first price point . . . ” to “store the calculated demand volume . . . ” for each price point of the plurality of available price points for the first financial product segment; and determining an ideal price point for the first financial product segment based on the determined demand volume data.

In such embodiments, the computer program product may further comprise applying the ideal price point to the first financial product segment.

In some embodiments of the invention, the computer program product further comprises monitoring one or more network databases for changes to the hypothetical customer profile data and the competing financial product data; determining that one of the hypothetical customer profile data or the competing financial product data has changed; and updating the one or more network databases associated with the hypothetical customer profile data or the competing financial product data with the changed data.

In some embodiments of the computer program product, the first financial product is a loan refinancing product. In some embodiment of the computer program product, the first financial product is a purchase loan product.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 depicts a method for predicting the demand for a loan refinancing product in accordance with an aspect of the present invention;

FIG. 2 depicts an exemplary system for predicting the demand for a loan refinancing product in accordance with an aspect of the present invention;

FIG. 3A depicts historical data representing funded refinance applications during the 4th quarter of 2010 by a particular financial institution, which indicate that almost all customers who chose to purchase a loan refinancing product saved at least $50 on their monthly payment;

FIG. 3B depicts historical data representing funded refinance applications during the 4th quarter of 2010 by a particular financial institution, which indicate that almost all customers who chose to purchase a loan refinancing product saved at least 5% on their monthly payment;

FIG. 4 depicts a method for predicting the demand for a purchase loan product in accordance with an aspect of the present invention;

FIG. 5 depicts an exemplary system for predicting the demand for a purchase loan product in accordance with an aspect of the present invention;

FIG. 6 depicts an exemplary system for reducing computation costs associated with predicting a demand for a financial product;

FIGS. 7A through 7B depict a method for reducing computation cost associated with predicting a demand for a financial product; and

FIG. 8 depicts a process flow for identifying cannibalization between two or more segments, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like.

In one aspect, the present invention embraces a customer centric system and method for pricing loan refinancing products. More particularly, this aspect of the present invention typically relates to a system and method for predicting the demand of one or more loan refinancing products offered by a financial institution. By predicting the demand for a plurality of hypothetical loan refinancing products being offered at different prices (e.g., at different interest rates), a financial institution can determine at which price to offer a loan refinancing product.

In order to predict the demand for a first loan refinancing product, the system and method in accordance with the present invention typically simulate the decision making process for each of a plurality of hypothetical customers. More particularly, the likelihood of each hypothetical customer choosing between the first loan refinancing product and one or more competing loan refinancing products is typically simulated. The likelihood of a hypothetical customer choosing a particular loan refinancing product is based upon principles as described herein.

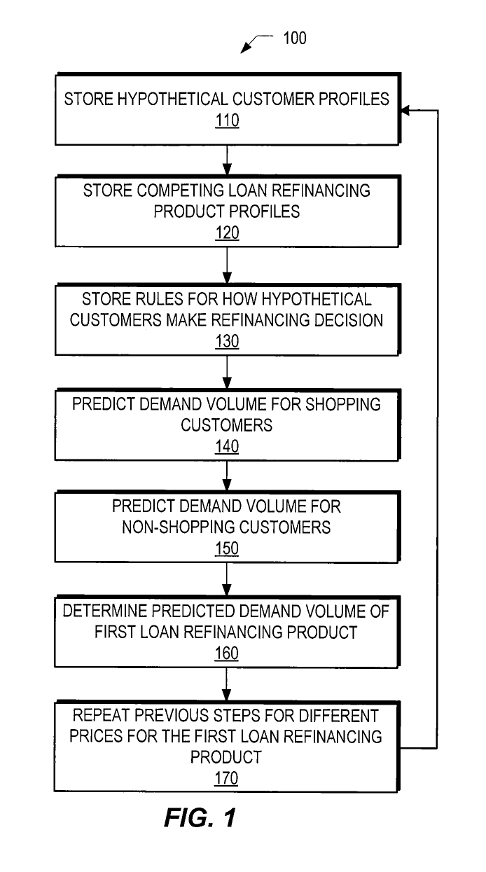

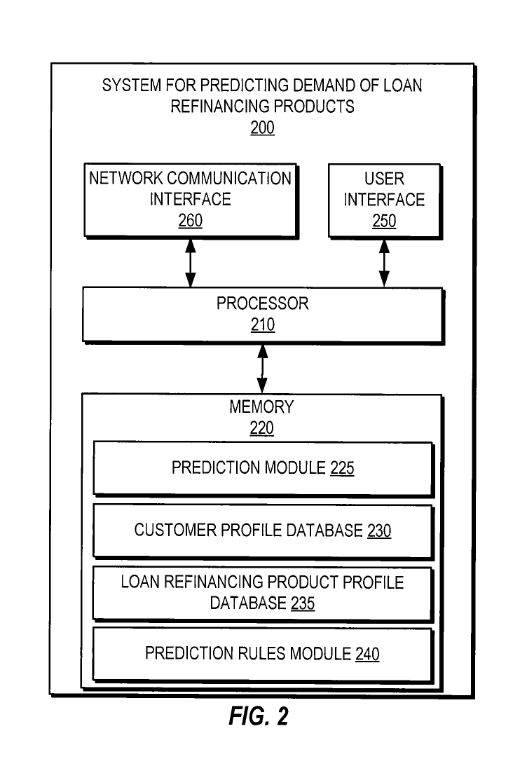

A method 100 for predicting the demand for a first loan refinancing product (e.g., for mortgage refinancing) offered by a first financial institution in accordance with one aspect of the present invention is depicted in FIG. 1. An exemplary system 200 for predicting the demand for the first loan refinancing product is depicted in FIG. 2. As depicted in FIG. 2, the system 200 typically includes a processor 210 and a memory 220. A prediction module 225 is typically stored in the memory 220 and is executable by the processor 210 to perform one or more of the steps of the method 100. The system 200 may also include a user interface 250 and network communication interface 260 for communicating with other devices and systems.

In step 110, a plurality of customer profiles reflecting a plurality of hypothetical shopping customers are stored (e.g., in a customer profile database 230). The hypothetical customers reflect the makeup of customers expected to be shopping for loan refinancing products during a predetermined period of time (e.g., a week, a month, or a year). In other words, the hypothetical customers when aggregated should reflect the makeup of expected shopping customers (e.g., in terms of financial makeup). Accordingly, the makeup of the hypothetical customers may be based upon various factors including the expected size of the market for loan refinancing products (e.g., based upon historical market size data from the past week or month) and the expected financial makeup (e.g., current loan rate, current loan monthly payment, credit score, and current loan-to-value ratio) of the customers. In one embodiment, the total number of hypothetical customers is equal to the expected total number of shopping customers, where the expected total number of shopping customers may be based upon various factors including the expected size of the market for loan refinancing products (e.g., based upon historical market size data from the past week or month). In an alternative embodiment, the hypothetical customers are a representative sample of the expected total number of shopping customers.

Each customer profile typically includes a rate Rₖ reflecting a current loan rate of a hypothetical shopping customer k and a monthly payment C(Rₖ) reflecting a current monthly loan payment of the hypothetical customer k. Other information, such as each hypothetical customer's remaining loan balance, credit score, and current loan-to-value ratio may also be included in the customer profiles.

As used herein, a “shopping customer” is a customer shopping for loan refinancing products at a plurality of financial institutions. In shopping between loan refinancing products, shopping customers are expected to select a loan refinancing product based upon price, more typically the monthly savings between the loan refinancing product and the customer's current monthly loan payment, and a non-price value (e.g., convenience, brand value, footprint, marketing activity, sales forces ability, and/or time to closing) of the financial institution offering the loan refinancing product. In contrast, a “non-shopping customer” is a customer that does not shop for loan refinancing products at a plurality of financial institutions. Instead, a “non-shopping customer” will only choose (or not choose) a loan refinancing product from a financial institution that the non-shopping customer has a strong relationship with (e.g., the financial institution that is the customer's current mortgage servicer) and without comparing loan refinancing products offered by other financial institutions.

As used herein, a “non-price value” may be a fit parameter value based on the convenience, brand value, footprint, marketing activity, sales force ability, and/or time to closing of the financial institution offering a loan refinancing product. In some embodiments, the non-price value is a scalar variable. The non-price value accounts for the discrepancy between the expected value of a loan refinancing product based on its pricing information (e.g., loan amount, interest rate, duration of a loan, and the like) and the actual market value of the loan refinancing product. The discrepancies result from non-price factors that influence a loan refinancing product's worth to potential customers. For example, a new marketing strategy can increase the non-price value of a loan refinancing product by increasing the non-price factor of brand value. This increase in the non-price factor may cause the market price to exceed the expected price of the loan refinancing product. Of course, non-price factors can also negatively influence the non-price value of a loan refinancing product, reducing the market value of the loan refinancing product in the eyes of potential customers to an amount below the expected value.

In some embodiments, a financial institution may assign a non-price value to a loan refinancing product and use this non-price value when making demand volume calculations. This non-price value may simply be an estimate non-price value based on known non-price factors. In some embodiments, a user of the system may estimate a non-price value based on historical data. In some embodiments, a user of the system may apply a first non-price value to historical data and test the non-price value's effectiveness in representing the influence of non-price factors on a market price of a loan refinancing product, based on the historical data. In such embodiments, the user of the system may then adjust the non-price value to better represent the influence of non-price factors on the market price of the loan refinancing product, based on the historical data. The user of the system may repeat this process until a satisfactory non-price value is determined. In other embodiments, the non-price value may be determined using a regression analysis of historical data associated with the loan refinancing product, the financial institution offering the loan refinancing product, and the non-price factors associated with the loan refinancing product. In such embodiments, the non-price value may be the value that most closely fits the expected value of the loan refinancing product to the actual market value of the loan refinancing product over time. Regression analysis may uses any regression analysis model that is capable of determining a good fit parameter, based on the historical data. Examples of regression analysis models include, but are not limited to, linear regression, simple regression, polynomial regression, general linear model regression, non-linear regression, least squares, weighted regression, and the like. Historical data may be historical transaction data or any other data that provides information about prices and volume of one or more loan refinancing products over a period of time in the past.

In step 120, a plurality of competing loan refinancing product profiles reflecting a plurality of hypothetical competing loan refinancing products are stored (e.g., in a loan refinancing product profile database 235). The hypothetical competing loan refinancing products reflect the makeup of competing loan refinancing products expected to be available (e.g., available to the hypothetical customers) during the predetermined period of time. In other words, the hypothetical competing loan refinancing products when aggregated should reflect the makeup of expected competing loan refinancing products (e.g., in terms of loan rate). Accordingly, the makeup of the hypothetical competing loan refinancing products may be based upon recent (e.g., from the past week or month) competitor price data. Each competing loan refinancing product profile includes a rate R₁ reflecting a loan rate of a competing loan refinancing product l.

In step 130, a plurality of rules for determining how each hypothetical shopping customer makes a loan refinancing decision are stored (e.g., in a prediction rules module 240). These rules typically include (i) rules for determining whether each hypothetical shopping customer will decide to purchase a loan refinancing product and (ii) rules for determining which loan refinancing product each hypothetical shopping customer will decide to purchase (e.g., choosing from the first loan refinancing product and the hypothetical competing loan refinancing products).

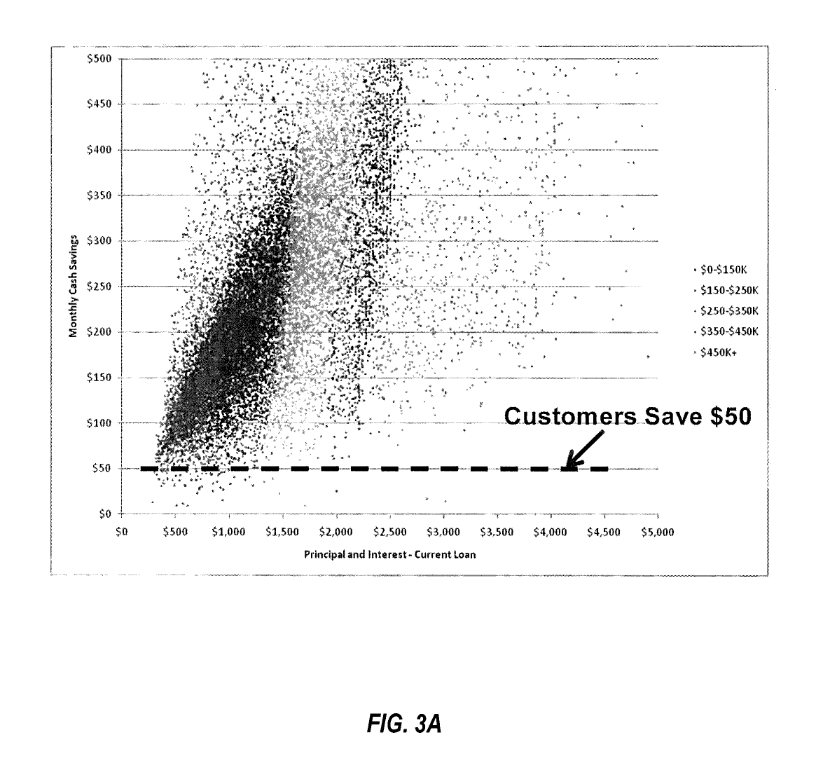

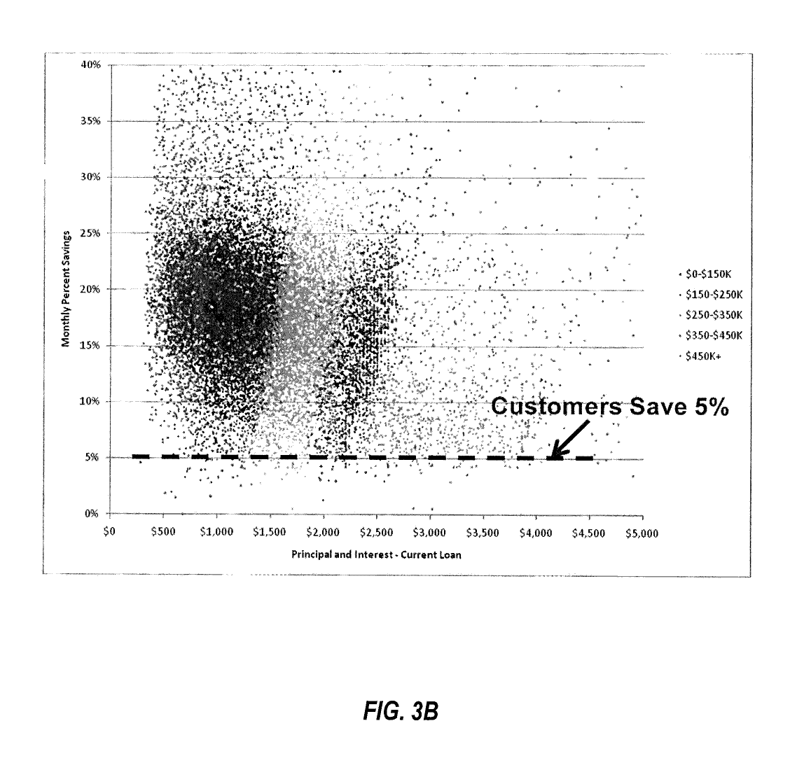

In determining whether a hypothetical customer k will decide to purchase a loan refinancing product, the customer's current monthly payment C(Rₖ) is compared against the expected monthly loan payment for each loan refinancing product (e.g., for the first loan refinancing product and for the competing loan refinancing products). In this regard, a hypothetical customer k will typically only decide to purchase a loan refinancing product if the expected monthly payment of the loan refinancing product is less than the current monthly loan payment C(Rₖ) of the hypothetical customer k. More typically, a hypothetical customer k will typically only decide to purchase a loan refinancing product if the expected monthly payment of the loan refinancing product is at least a predefined amount and/or a predefined percentage less than the current monthly loan payment C(Rₖ) of the hypothetical customer k. In a specific embodiment, the expected monthly payment must be at least 5% less than and at least $50 less than the current monthly loan payment C(Rₖ) of the hypothetical customer k. It has found that customers who choose to purchase a loan refinancing product typically save at least $50 and at least 5% on their monthly payment. In this regard, FIG. 3A depicts historical data representing funded refinance applications during the 4^{th} quarter of 2010 by a particular financial institution, which indicate that almost all customers who chose to purchase a loan refinancing product saved at least $50 on their monthly payment. Furthermore, FIG. 3B depicts historical data representing funded refinance applications during the 4^{th} quarter of 2010 by a particular financial institution, which indicate that almost all customers who chose to purchase a loan refinancing product saved at least 5% on their monthly payment.

Of course, the example rule applications are non-exhaustive, and the hypothetical customer k may consider the expected monthly payment amount and/or the predefined percentage less than the currently monthly loan payment C(Rₖ) to be different values than what is described above. For example, the hypothetical customer k be at least 7% less than and at least $55 less than the current monthly loan payment C(Rₖ).

In determining which loan refinancing product a hypothetical customer k will decide to purchase, the hypothetical customer k evaluates the monthly savings offered by each loan refinancing product as well as the non-price value of the financial institution offering each loan refinancing product. In one embodiment, the monthly savings of each loan refinancing product is multiplied by the non-price value of the financial institution offering the loan to determine a savings value for each loan refinancing product. The probability of the hypothetical customer k selecting any one of the loan refinancing products is then equal to the savings value of the loan refinancing product divided by the sum of the savings values of all of the loan refinancing products. Table 1 (below) illustrates the probability of a hypothetical customer selecting between an exemplary loan refinancing product being offered by a first financial institution and four competing loan refinancing products.

TABLE 1

| | | | Competing | Competing | Competing | Competing |
|---|---|---|---|---|---|---|
| | | Loan Offered | Loan Offered | Loan Offered | Loan Offered | Loan Offered |
| | Customer's | by First | by Second | by Third | by Fourth | by Fifth |
| | Current | Financial | Financial | Financial | Financial | Financial |
| | Loan | Institution | Institution | Institution | Institution | Institution |
| Rate | 5.25% | 4.75% | 4.875% | 5.50% | 4.625% | 4.875% |
| Monthly | $1,104 | $1,043 | $1,058 | $1,136 | $1,028 | $1,058 |
| Payment | | | | | | |
| Savings | | $61 | $46 | $0 | $76 | $46 |
| Non-Price | | 1.0 | 1.30 | 0.85 | 0.70 | 0.05 |
| Value | | | | | | |
| Savings Value | | 61.1 | 59.8 | 0.0 | 53.3 | 2.3 |
| Customer | | 35% | 34% | 0% | 30% | 1% |
| Decision | | | | | | |
| Probability | | | | | | |

The non-price value for each financial institution relates to various factors, which may include convenience, brand value, footprint, marketing activity, sales forces ability, and/or time to closing. A non-price value may be assigned to each financial institution. Alternatively, the non-price value of each financial institution may be determined by analyzing historical volume data for loan refinancing products at each financial institution to determine a non-price value that best fits the historical volume data (e.g., using regression analysis). In one embodiment, the non-price value of each financial institution may vary by geographic region. For example, a financial institution may have a higher non-price value in one region and a lower non-price value in another region. Non-price values determined from analyzing historical volume data may be adjusted to reflect recent changes to the financial institutions (e.g., recent growth, marketing campaigns, and/or strategy changes) that may not be fully reflected in the historical volume data.

In step 140, the demand volume of the shopping customers for the first loan refinancing product during the predetermined period of time is predicted by simulating the decision of each hypothetical shopping customer as described above. The demand volume of the shopping customers for the first loan refinancing product is typically the sum of the probabilities of each hypothetical shopping customer selecting the first loan refinancing product. For example, if there are 100 hypothetical shopping customers, each with a 10% probability of selecting a first loan refinancing product, then the predicted demand volume of the first loan refinancing product will be 10.

Accordingly, the demand volume of the shopping customers for the first loan refinancing product being offered at an interest rate of Rᵢₙₛₜ₁ may be modeled as:

$$γ {\sum }_{k} \frac{{W}_{inst 1 , k} \times ( C ( {R}_{k} ) - {C}_{k} ( {R}_{inst 1} ) )}{{W}_{inst 1 , k} \times ( C ( {R}_{k} ) - {C}_{k} ( {R}_{inst 1} ) ) + {\sum }_{l} {W}_{l , k} \times ( C ( {R}_{k} ) - {C}_{k} ( {R}_{l} ) )}$$

wherein γ is the ratio of the total number of expected shopping customers over the total number of hypothetical shopping customers, Rᵢₙₛₜ₁ is i the loan rate of the first loan refinancing product, Cₖ(Rᵢₙₛₜ₁) is the expected monthly loan payment of the first loan refinancing product for the customer k, and Cₖ(Rₗ) is the expected monthly loan payment of the competing loan refinancing product l for the customer k. This equation produces the sum of the decision probabilities for all of the hypothetical customers, which is then multiplied by the ratio γ of the total number of expected shopping customers over the total number of hypothetical shopping customers. For example, if the number of hypothetical customers is equal to the number of expected shopping customers, then γ=1. By way of further example, if the number of hypothetical customers is 100 and the number of expected shopping customers is 10,000, then γ=100.

The weighting function W_{inst1,k} is typically defined as:

$${W}_{inst 1 , k} = {w}_{inst 1} \times \frac{d {R}_{inst 1}}{d {P}_{inst 1}} \times {\partial }_{inst 1 , k}$$

wherein Wᵢₙₛₜ₁ is the non-price value of the first financial institution,

$$\frac{d {R}_{inst 1}}{d {P}_{inst 1}}$$

is the rate at which points paid can buy down the rate Rᵢₙₛₜ₁ of the first loan refinancing product, and ∂_{inst1,k} is a conditional function defined as:

∂_{inst1,k}=0 if C(Rₖ)+αC(Rₖ)<Cₖ(Rᵢₙₛₜ₁) or C(Rₖ)+β<Cₖ(Rᵢₙₛₜ₁)

∂_{inst1,k}=0 if customer k is ineligible for the first loan refinancing product
∂_{inst1,k}=1 otherwise
wherein α is a predetermined minimum percentage difference β and is a predetermined minimum difference. The predetermined minimum percentage difference α and the a predetermined minimum difference β ensure that the expected monthly payment Cₖ(Rᵢₙₛₜ₁) of the first loan refinancing product is sufficiently less than (e.g., at least 5% and $50 less than) the hypothetical customer's current monthly payment C(Rₖ). The conditional function ∂_{inst1,k} also ensures that the hypothetical customer k is eligible for the first loan refinancing product.

The weighting function W_{l,k} is typically defined as:

$${W}_{l , k} = {w}_{l} \times \frac{d {R}_{l}}{d {P}_{l}} \times {\partial }_{l , k}$$

wherein wₗ is the non-price value of the financial institution offering the competing loan refinancing product

$$l , \frac{d {R}_{l}}{d {P}_{l}}$$

is the rate at which points paid can buy down the rate R₁ of the competing loan refinancing product l, and ∂_{l,k} is a conditional function defined as:

∂_{l,k}=0 if C(Rₖ)+αC(Rₖ)<Cₖ(Rₗ) or C(Rₖ)+β<Cₖ(Rₗ)

∂_{l,k}=0 if customer k is ineligible for a competing loan refinancing product l
∂_{l,k}=1 otherwise
wherein α is the predetermined minimum percentage difference β and is the predetermined minimum difference. The predetermined minimum percentage difference α and the a predetermined minimum difference β ensure that the expected monthly payment Cₖ(Rₗ) of the competing loan refinancing product l is sufficiently less than (e.g., at least 5% and $50 less than) the hypothetical customer's current monthly payment C(Rₖ). The conditional function ∂_{l,k} also ensures that the hypothetical customer k is eligible for the competing loan refinancing product l and, thus, accounts for the possibility that different competing financial institutions may have different qualifying criteria.

In step 150, the demand volume of non-shopping customers for the first loan refinancing product during the predetermined period of time is predicted. As used herein, a “non-shopping customer” is a customer who will only choose (or not choose) a loan refinancing product from a financial institution that the non-shopping customer has a strong relationship with (e.g., the financial institution that is the customer's current mortgage servicer) and without comparing loan refinancing products offered by other financial institutions. It has been found that a significant percentage (e.g., about 60%) of loan refinancing products sales come from non-shopping customers.

In order to predict the demand volume of non-shopping customers, historical volume data for loan refinancing products is typically analyzed to determine a historical ratio of the demand volume from non-shopping customers to the demand volume from shopping customers. For example, the above described model for determining the demand volume of the shopping customers for the first loan refinancing product may be applied to historical volume data (e.g., from the previous month or year) for loan refinancing products from the first financial institution to determine a historical ratio of the demand volume from non-shopping customers to the demand volume from shopping customers at the first financial institution (e.g., a ratio that best fits the historical volume data). Alternatively, the above described model for determining the demand volume of the shopping customers may be applied to historical market volume data (e.g., from the previous month or year) for loan refinancing products to determine a historical ratio of the demand volume from non-shopping customers to the demand volume from shopping customers in the entire market for loan refinancing products (e.g., a ratio that best fits the historical volume data). Once a historical ratio of the demand volume from non-shopping customers to the demand volume from shopping customers has been determined, this ratio may be multiplied by the predicted volume of shopping customers to thereby predict the volume of non-shopping customers. Alternatively, the historical ratio of the demand volume from non-shopping customers to the total demand volume (e.g., derived from the historical ratio of the demand volume from non-shopping customers to the demand volume from shopping customers) may be multiplied (i) by the expected total size of the market for loan refinancing products (e.g., derived from recent market size data from the past week, month, or year) and (ii) by the first financial institution's expected market share or expected percentage of the total market for loan refinancing products (e.g., derived from recent market size and market share data from the past week, month, or year) to thereby predict the volume of non-shopping customers.

In one embodiment, historical volume data for loan refinancing products may be analyzed to determine a relationship between the interest rate and the demand volume from non-shopping customers. The interest rate Rᵢₙₛₜ₁ of the first loan refinancing product may then be inserted into this relationship to thereby predict the volume of non-shopping customers for the first loan refinancing product. Varying the number of non-shopping customers as a function of interest rate may provide for a more accurate prediction when the interest rate of the first loan refinancing product significantly departs from recent interest rates than applying the demand volume model to historical data as described above.

It is expected that the demand from non-shopping customers for products offered by a particular financial institution may vary by geographic region. For example, the footprint of a financial institution may vary by region. Accordingly, in one embodiment, the volume of non-shopping customers for the first loan refinancing product may be separately predicted for each geographic region.

In step 160, the predicted demand volume Vᵢₙₛₜ₁ of the first loan refinancing product is determined. The predicted demand volume Vᵢₙₛₜ₁ of the first loan refinancing product is equal to the sum of (i) the demand volume from shopping customers and (ii) the demand volume from non-shopping customers. Accordingly, the demand volume Vᵢₙₛₜ₁ of the first loan refinancing product may be modeled as:

$${V}_{inst 1} = {n}_{inst 1} + γ {\sum }_{k} \frac{{w}_{inst 1 , k} \times ( C ( {R}_{k} ) - {C}_{k} ( {R}_{inst 1} ) )}{{w}_{inst 1 , k} \times ( C ( {R}_{k} ) - {C}_{k} ( {R}_{inst 1} ) ) + {\sum }_{l} {w}_{l , k} \times ( C ( {R}_{k} ) - {C}_{k} ( {R}_{l} ) )}$$

wherein nᵢₙₛₜ₁ is the demand volume from non-shopping customers.

As described above, this demand volume model for a loan refinancing product may be applied to historical volume data for loan refinancing products to determine values for the fit parameters, namely the demand volume nᵢₙₛₜ₁ from non-shopping customers and the non-price value (i.e., wᵢₙₛₜ₁ and wₗ) of the various financial institutions offering loan refinancing products that best fit the historical volume data (e.g., using regression analysis). Once determined, these fit parameters can be employed in the model to predict the demand for the first loan refinancing product offered by the first financial institution during the predetermined period of time. Similarly, the demand volume model can be employed to predict the demand volume for each of the competing loan refinancing products.

In one embodiment, the first financial institution may offer more than one loan refinancing product. In such a circumstance, the foregoing demand volume model may be currently simulated for each loan refinancing product offered by the first financial institution, where the other loan refinancing product offered by the first financial institution is treated as a competing loan refinancing product. For example, if the first financial institution offers a first loan refinancing product and a second loan refinancing product, the demand volume model is run (i) for the first loan refinancing product where the second loan refinancing product is treated as a competing product and (ii) for second loan refinancing product wherein the first loan refinancing product is treated as a competing product.

In step 170, the previous steps (i.e., steps 110-160) may be repeated for a plurality of different prices, typically different interest rates, for the first loan refinancing product to predict the demand volume of the first loan refinancing product at each of the different prices. The combination of price and predicted volume of the first loan refinancing product may then be employed by the first financial institution to determine the price at which to offer the first loan refinancing product in the market.

The demand volume model for loan refinancing products in accordance with the present invention has been found to be significantly more accurate than previous product-level elasticity models in predicting the demand for a loan refinancing product. In this regard, the present demand volume model was tested by running the model over the 2010 calendar year for sales of conforming fixed loan refinancing products at a particular financial institution. The above described fit parameters (e.g., volume of non-shopping customers and the non-price value of the different competing financial institutions) were determined using a deterministic round-robin downhill method on the previous 30 days of data. The results of this model were compared against the actual sales volume during the 2010 calendar year. The present demand volume model was found to have an average error (i.e., different from the actual sales volume) of 8.1%.

A product-level elasticity model was also run over the 2010 calendar year for sales of conforming fixed loan refinancing products at the particular financial institution. In comparison with the actual sales volume during the 2010 calendar year, the product-level elasticity model was found to have an average error of 16.1%. Accordingly, the present demand volume model has a significant reduction in error as compared with product-level elasticity models.

In another aspect, the present invention embraces a customer centric system and method for pricing purchase loan products (e.g., mortgages). More particularly, this aspect of the present invention typically relates to a system and method for predicting the demand of one or more purchase loan products offered by a financial institution. By predicting the demand for a plurality of hypothetical purchase loan products being offered at different prices (e.g., at different interest rates), a financial institution can determine at which price to offer a purchase loan product.

In order to predict the demand for a first purchase loan product, the system and method in accordance with the present invention typically simulate the decision making process for each of a plurality of hypothetical customers. More particularly, the likelihood of each hypothetical customer choosing between the first purchase loan product and one or more competing purchase loan products is typically simulated. The likelihood of a hypothetical customer choosing a particular purchase loan product is based upon principles as described herein.

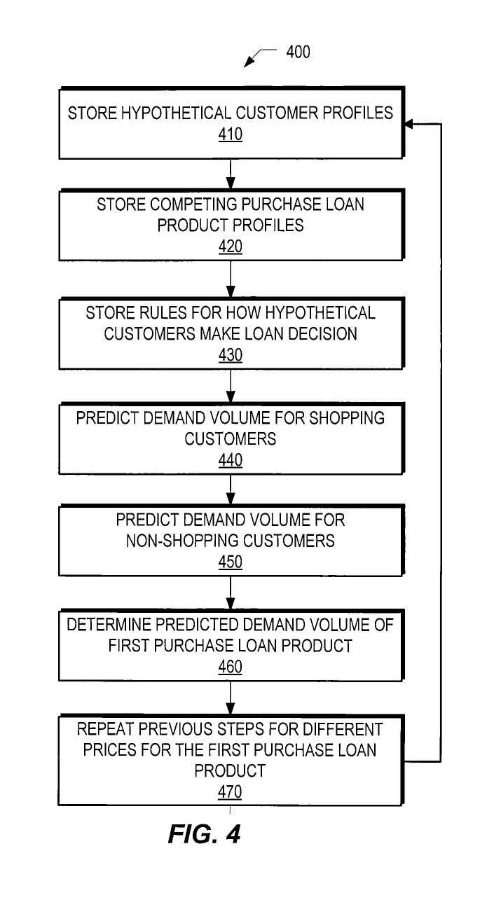

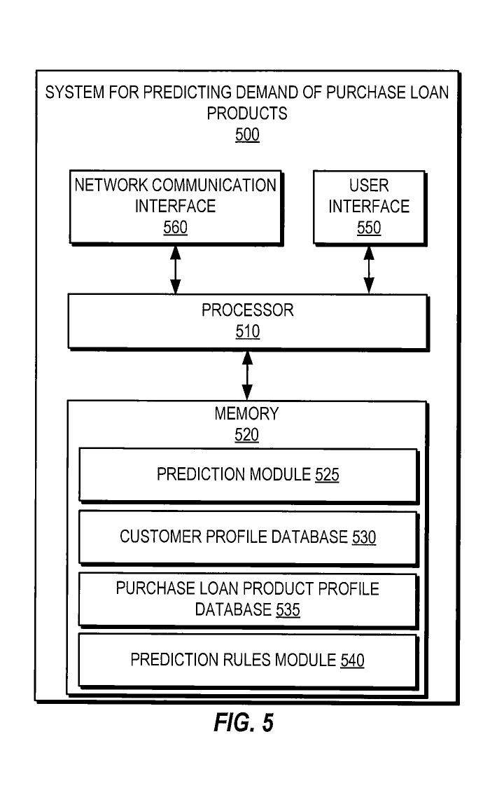

A method 400 for predicting the demand for a first purchase loan product offered by a first financial institution in accordance with one aspect of the present invention is depicted in FIG. 4. An exemplary system 500 for predicting the demand for the first purchase loan product is depicted in FIG. 5. As depicted in FIG. 5, the system 500 typically includes a processor 510 and a memory 520. A prediction module 525 is typically stored in the memory 520 and is executable by the processor 510 to perform one or more of the steps of the method 400. The system 500 may also include a user interface 550 and a network communication interface 560 for communicating with other devices and systems.

In step 410, a plurality of customer profiles reflecting a plurality of hypothetical shopping customers are stored (e.g., in a customer profile database 530). The hypothetical customers reflect the makeup of customers expected to be shopping for purchase loan products during a predetermined period of time (e.g., a week, a month, or a year). In other words, the hypothetical customers when aggregated should reflect the makeup of expected shopping customers (e.g., in terms of financial makeup). Accordingly, the makeup of the hypothetical customers may be based upon various factors including the expected size of the market for purchase loan products (e.g., based upon historical market size data from the past week or month) and the expected financial makeup (e.g., expected loan amount, current income, credit score, current loan-to-value ratio, and maximum acceptable debit-to-income ratio) of the customers. In this regard, the distribution of maximum acceptable debt-to-income ratios of the hypothetical customers should reflect the distribution of the debt-to-income ratios of customers who purchased purchase loan products as found in recent historical data (e.g., from the previous month). In one embodiment, the distribution of maximum acceptable debt-to-income ratios for the hypothetical customers may vary by geographic region. For example, hypothetical customers may, on average, have higher maximum acceptable debt-to-income ratios in geographic regions having a high cost of living than hypothetical customers in geographic regions having a lower cost of living. In one embodiment, the total number of hypothetical customers is equal to the expected total number of shopping customers, where the expected total number of shopping customers may be based upon various factors including the expected size of the market for purchase loan products (e.g., based upon historical market size data from the past week or month). In an alternative embodiment, the hypothetical customers are a representative sample of the expected total number of shopping customers.

Each customer profile typically includes a maximum acceptable debit-to-income ratio DTI_{max,k} (e.g., based upon customer preference) and a maximum acceptable monthly payment Cₖ(DTI_{max,k}), which reflects the maximum acceptable monthly payment for the hypothetical customer k based upon the hypothetical customer's maximum acceptable debit-to-income ratio DTI_{max,k}. The maximum acceptable debt-to-income ratios of the hypothetical customer's will typically vary (e.g., each hypothetical customer may have a unique maximum acceptable debt-to-income ratio). Because a customer's maximum acceptable debt-to-income ratio is typically based upon the customer's preference and not loan requirements, a hypothetical's customer's maximum acceptable debt-to-income ratio may be more or less than a maximum debt-to-income ratio allowed by a financial institution offering a purchase loan product. Other information, such as each hypothetical customer's expected loan amount, income, credit score, and loan-to-value ratio may also be included in the customer profiles.

As used herein, a “shopping customer” is a customer shopping for purchase loan products at a plurality of financial institutions. In shopping between purchase loan products, shopping customers are expected to select a purchase loan product based upon price, more typically the difference between the expected monthly payment for the purchase loan product and the customer's maximum acceptable monthly payment, and a non-price value (e.g., convenience, brand value, footprint, marketing activity, sales forces ability, and/or time to closing) of the financial institution offering the purchase loan product. In contrast, a “non-shopping customer” is a customer that does not shop for purchase loan products at a plurality of financial institutions. Instead, a “non-shopping customer” will only choose (or not choose) a purchase loan product from a financial institution without comparing purchase loan products offered by other financial institutions.

As used herein, a “non-price value” may be a fit parameter value based on the convenience, brand value, footprint, marketing activity, sales force ability, and/or time to closing of the financial institution offering a purchase loan product. In some embodiments, the non-price value is a scalar variable. The non-price value accounts for the discrepancy between the expected value of a purchase loan product based on its pricing information (e.g., loan amount, interest rate, duration of a loan, and the like) and the actual market value of the purchase loan product. The discrepancies result from non-price factors that influence a purchase loan product's worth to potential customers. For example, a new marketing strategy can increase the non-price value of a purchase loan product by increasing the non-price factor of brand value. This increase in the non-price factor may cause the market price to exceed the expected price of the purchase loan product. Of course, non-price factors can also negatively influence the non-price value of a purchase loan product, reducing the market value of the purchase loan product in the eyes of potential customers to an amount below the expected value.

In some embodiments, a financial institution may assign a non-price value to a purchase loan product and use this non-price value when making demand volume calculations. This non-price value may simply be an estimate non-price value based on known non-price factors. In some embodiments, a user of the system may estimate a non-price value based on historical data. In some embodiments, a user of the system may apply a first non-price value to historical data and test the non-price value's effectiveness in representing the influence of non-price factors on a market price of a purchase loan product, based on the historical data. In such embodiments, the user of the system may then adjust the non-price value to better represent the influence of non-price factors on the market price of the purchase loan product, based on the historical data. The user of the system may repeat this process until a satisfactory non-price value is determined. In other embodiments, the non-price value may be determined using a regression analysis of historical data associated with the purchase loan product, the financial institution offering the purchase loan product, and the non-price factors associated with the purchase loan product. In such embodiments, the non-price value may be the value that most closely fits the expected value of the purchase loan product to the actual market value of the purchase loan product over time. Regression analysis may uses any regression analysis model that is capable of determining a good fit parameter, based on the historical data. Examples of regression analysis models include, but are not limited to, linear regression, simple regression, polynomial regression, general linear model regression, non-linear regression, least squares, weighted regression, and the like. Historical data may be historical transaction data or any other data that provides information about prices and volume of one or more purchase loan products over a period of time in the past.

In step 420, a plurality of competing purchase loan product profiles reflecting a plurality of hypothetical competing purchase loan products are stored (e.g., in a purchase loan product profile database 535). The hypothetical competing purchase loan products reflect the makeup of competing purchase loan products expected to be available (e.g., available to the hypothetical customers) during the predetermined period of time. In other words, the hypothetical competing purchase loan products when aggregated should reflect the makeup of expected competing purchase loan products (e.g., in terms of loan rate). Accordingly, the makeup of the hypothetical competing purchase loan products may be based upon recent (e.g., from the past week or month) competitor price data. Each competing purchase loan product profile includes a rate Rₚ reflecting a loan rate of a competing purchase loan product p.

In step 430, a plurality of rules for determining how each hypothetical shopping customer makes a purchase loan decision are stored (e.g., in a prediction rules module 540). These rules typically include (i) rules for determining whether each hypothetical shopping customer will decide to purchase a purchase loan product and (ii) rules for determining which purchase loan product each hypothetical shopping customer will decide to purchase (e.g., choosing from the first purchase loan product and the hypothetical competing purchase loan products).

In determining whether a hypothetical customer k will decide to purchase a purchase loan product, the customer's maximum acceptable monthly payment Cₖ(DTI_{max,k}) is compared against the expected monthly loan payment for each purchase loan product (e.g., for the first purchase loan product and for the competing purchase loan products). In this regard, a hypothetical customer k will typically only decide to purchase a purchase loan product if the expected monthly payment of the purchase loan product is less than the customer's maximum acceptable monthly payment Cₖ(DTI_{max,k}).

In determining which purchase loan product a hypothetical customer k will decide to purchase, the hypothetical customer k evaluates the monthly payment of each purchase loan product as well as the non-price value of the financial institution offering each purchase loan product. In one embodiment, the difference between the customer's maximum acceptable monthly payment Cₖ(DTIₘₐₓ) and the monthly payment of each purchase loan product is multiplied by the non-price value of the financial institution offering the loan to determine a DTI differential value for each purchase loan product. The DTI differential value, however, is 0 if the expected monthly payment of the purchase loan product is greater than the customer's maximum acceptable monthly payment Cₖ(DTIₘₐₓ). The probability of the hypothetical customer k selecting any one of the purchase loan products is then equal to the DTI differential value of the purchase loan product divided by the sum of the DTI differential values of all of the purchase loan products. Table 2 (below) illustrates the probability of a hypothetical customer selecting between an exemplary purchase loan product being offered by a first financial institution and four competing purchase loan products.

TABLE 2

| | Customer's | | Competing | Competing | Competing | Competing |
|---|---|---|---|---|---|---|
| | Maximum | Loan Offered | Loan Offered | Loan Offered | Loan Offered | Loan Offered |
| | Acceptable | by First | by Second | by Third | by Fourth | by Fifth |
| | Monthly | Financial | Financial | Financial | Financial | Financial |
| | Payment | Institution | Institution | Institution | Institution | Institution |
| Rate | | 4.75% | 4.875% | 5.50% | 4.625% | 4.875% |
| Monthly | $1,104 | $1,043 | $1,058 | $1,136 | $1,028 | $1,058 |
| Payment | | | | | | |
| Difference | | $61 | $46 | −$32 | $76 | $46 |
| Non-Price | | 1.0 | 1.30 | 0.85 | 0.70 | 0.05 |
| Value | | | | | | |
| DTI | | 61.1 | 59.8 | 0.0 | 53.3 | 2.3 |
| Differential | | | | | | |
| Value | | | | | | |
| Customer | | 35% | 34% | 0% | 30% | 1% |
| Decision | | | | | | |
| Probability | | | | | | |

The non-price value for each financial institution relates to various factors, which may include convenience, brand value, footprint, marketing activity, sales forces ability, and/or time to closing. A non-price value may be assigned to each financial institution. Alternatively, the non-price value of each financial institution may be determined by analyzing historical volume data for purchase loan products at each financial institution to determine a non-price value that best fits the historical volume data (e.g., using regression analysis). In one particular embodiment, a value is assigned for the non-price value of one financial institution, and a non-price value is determined for each financial institution offering a competing purchase loan product by applying the demand volume model described herein to historical volume data for purchase loan products at each financial institution offering each competing purchase loan product to determine a value for the non-price value of each financial institution offering each competing purchase loan product that best fits the historical volume data for purchase loan products at each financial institution offering each competing purchase loan product. In one embodiment, the non-price value of each financial institution may vary by geographic region. For example, a financial institution may have a higher non-price value in one region and a lower non-price value in another region. Non-price values determined from analyzing historical volume data may be adjusted to reflect recent changes to the financial institutions (e.g., recent growth, marketing campaigns, and/or strategy changes) that may not be fully reflected in the historical volume data.

In step 440, the demand volume of the shopping customers for the first purchase loan product during the predetermined period of time is predicted by simulating the decision of each hypothetical shopping customer as described above. The demand volume of the shopping customers for the first purchase loan product is typically the sum of the probabilities of each hypothetical shopping customer selecting the first purchase loan product. For example, if there are 100 hypothetical shopping customers, each with a 10% probability of selecting a first purchase loan product, then the predicted demand volume of the first purchase loan product will be 10.

Accordingly, the demand volume of the shopping customers for the first purchase loan product being offered at an interest rate of Rₗₒₐₙ₁ may be modeled as:

$$γ {\sum }_{k} \frac{{W}_{loan 1 , k} \times ( {C}_{k} ( {DTI}_{max , k} ) - {C}_{k} ( {R}_{loan 1} ) )}{\begin{matrix}{W}_{loan 1 , k} \times ( {C}_{k} ( {DTI}_{max , k} ) - {C}_{k} ( {R}_{loan 1} ) ) + \\ {\sum }_{l} {W}_{p , k} \times ( {C}_{k} ( {DTI}_{max , k} ) - {C}_{k} ( {R}_{p} ) )\end{matrix}}$$

wherein γ is the ratio of the total number of expected shopping customers over the total number of hypothetical shopping customers, Rₗₒₐₙ₁ is the loan rate of the first purchase loan product, Cₖ(Rₗₒₐₙ₁) is the expected monthly loan payment of the first purchase loan product for the customer k, and Cₖ(Rₚ) is the expected monthly loan payment of the competing purchase loan product p for the customer k. This equation produces the sum of the decision probabilities for all of the hypothetical customers, which is then multiplied by the ratio γ of the total number of expected shopping customers over the total number of hypothetical shopping customers. For example, if the number of hypothetical customers is equal to the number of expected shopping customers, then γ=1. By way of further example, if the number of hypothetical customers is 100 and the number of expected shopping customers is 10,000, then γ=100.

The weighting function W_{loan1,k} is typically defined as:

$${W}_{loan 1 , k} = {w}_{loan 1} \times \frac{d {R}_{loan 1}}{d {P}_{loan 1}} \times {\partial }_{loan 1 , k}$$

wherein wᵢₙₛₜ₁ the non-price value of the first financial institution, dRᵢₙₛₜ₁/dPᵢₙₛₜ₁ is the rate at which points paid can buy down the rate Rₗₒₐₙ₁ of the first purchase loan product, and ∂_{loan1,k} is a conditional function defined as:

∂_{loan1,k}=0 if Cₖ(DTI_{max,k})<Cₖ(Rₗₒₐₙ₁)

∂_{loan1,k}=0 if customer k is ineligible for the first purchase loan product
∂_{loan1,k}=1 otherwise
The conditional function ∂_{loan1,k} ensures that the expected monthly payment of the purchase loan product is not greater than the customer's maximum acceptable monthly payment Cₖ(DTI_{max,k}). The conditional function ∂_{loan1,k} also ensures that the hypothetical customer k is eligible for the first purchase loan product. For example, a financial may require that a hypothetical customer have a debt-to-income ratio that is below a particular threshold.

The weighting function W_{p,k} is typically defined as:

$${W}_{p , k} = {w}_{p} \times \frac{d {R}_{p}}{d {P}_{p}} \times {\partial }_{p , k}$$

wherein wₚ is the non-price value of the financial institution offering the competing purchase loan product

$$p , \frac{d {R}_{p}}{d {P}_{p}}$$

is the rate at which points paid can buy down the rate Rₚ of the competing purchase loan product p, and ∂_{p,k} is a conditional function defined as:

∂_{p,k}=0 if Cₖ(DTIₘₐₓ)<Cₖ(Rₗₒₐₙ₁)

∂_{p,k}=0 if customer k is ineligible for a competing purchase loan product l
∂_{p,k}=1 otherwise
The conditional function ∂_{p,k} ensures that the expected monthly payment of the purchase loan product is not greater than the customer's maximum acceptable monthly payment Cₖ(DTI_{max,k}). The conditional function ∂_{p,k} also ensures that the hypothetical customer k is eligible for the competing purchase loan product p and, thus, accounts for the possibility that different competing financial institutions may have different qualifying criteria.

In step 450, the demand volume of non-shopping customers for the first purchase loan product during the predetermined period of time is predicted. As used herein, a “non-shopping customer” is a customer who will only choose (or not choose) a purchase loan product from a financial institution without comparing purchase loan products offered by other financial institutions. For example, many customers needing a mortgage for a home purchase choose a purchase loan product from a financial institution based upon the recommendations of their real estate agent without comparing products offered by other financial institutions. It is expected that a significant percentage of purchase loan products sales come from non-shopping customers.

In order to predict the demand volume of non-shopping customers, historical volume data for purchase loan products is typically analyzed to determine a historical ratio of the demand volume from non-shopping customers to the demand volume from shopping customers. For example, the above described model for determining the demand volume of the shopping customers for the first purchase loan product may be applied to historical volume data (e.g., from the previous month or year) for purchase loan products from the first financial institution to determine a historical ratio of the demand volume from non-shopping customers to the demand volume from shopping customers at the first financial institution (e.g., a ratio that best fits the historical volume data). Alternatively, the above described model for determining the demand volume of the shopping customers may be applied to historical market volume data (e.g., from the previous month or year) for purchase loan products to determine a historical ratio of the demand volume from non-shopping customers to the demand volume from shopping customers in the entire market for purchase loan products (e.g., a ratio that best fits the historical volume data). Once a historical ratio of the demand volume from non-shopping customers to the demand volume from shopping customers has been determined, this ratio may be multiplied by the predicted volume of shopping customers to thereby predict the volume of non-shopping customers. Alternatively, the historical ratio of the demand volume from non-shopping customers to the total demand volume (e.g., derived from the historical ratio of the demand volume from non-shopping customers to the demand volume from shopping customers) may be multiplied (i) by the expected total size of the market for purchase loan products (e.g., derived from recent market size data from the past week, month, or year) and (ii) by the first financial institution's expected market share or expected percentage of the total market for purchase loan products (e.g., derived from recent market size and market share data from the past week, month, or year) to thereby predict the volume of non-shopping customers.

In one embodiment, historical volume data for purchase loan products may be analyzed to determine a relationship between the interest rate and the demand volume from non-shopping customers. The interest rate Rₗₒₐₙ₁ of the first purchase loan product may then be inserted into this relationship to thereby predict the volume of non-shopping customers for the first purchase loan product. Varying the number of non-shopping customers as a function of interest rate may provide for a more accurate prediction when the interest rate of the first purchase loan product significantly departs from recent interest rates than applying the demand volume model to historical data as described above.

It is expected that the demand from non-shopping customers for products offered by a particular financial institution may vary by geographic region. For example, the footprint of a financial institution and the strength of its relationships with real estate agents may vary by region. Accordingly, in one embodiment, the volume of non-shopping customers for the first purchase loan product may be separately predicted for each geographic region.

In step 460, the predicted demand volume Vₗₒₐₙ₁ of the first purchase loan product is determined. The predicted demand volume Vₗₒₐₙ₁ of the first purchase loan product is equal to the sum of (i) the demand volume from shopping customers and (ii) the demand volume from non-shopping customers. Accordingly, the demand volume Vₗₒₐₙ₁ of the first purchase loan product may be modeled as:

$${V}_{loan 1} = {n}_{loan 1} + γ {\sum }_{k} \frac{{W}_{loan 1 , k} \times ( {C}_{k} ( {DTI}_{max , k} ) - {C}_{k} ( {R}_{loan 1} ) )}{\begin{matrix}{W}_{loan 1 , k} \times ( {C}_{k} ( {DTI}_{max , k} ) - {C}_{k} ( {R}_{loan 1} ) ) + \\ {\sum }_{l} {W}_{p , k} \times ( {C}_{k} ( {DTI}_{max , k} ) - {C}_{k} ( {R}_{p} ) )\end{matrix}}$$

wherein nₗₒₐₙ₁ is the demand volume from non-shopping customers.

As described above, this demand volume model for a purchase loan product may be applied to historical volume data for purchase loan products to determine values for the fit parameters, namely the demand volume nₗₒₐₙ₁ from non-shopping customers and the non-price value (i.e., wₗₒₐₙ₁ and wₚ) of the various financial institutions offering purchase loan products that best fit the historical volume data (e.g., using regression analysis). Once determined, these fit parameters can be employed in the model to predict the demand for the first purchase loan product offered by the first financial institution during the predetermined period of time. Similarly, the demand volume model can be employed to predict the demand volume for each of the competing purchase loan products.

In one embodiment, the first financial institution may offer more than one purchase loan product. In such a circumstance, the foregoing demand volume model may be currently simulated for each purchase loan product offered by the first financial institution, where the other purchase loan product offered by the first financial institution is treated as a competing purchase loan product. For example, if the first financial institution offers a first purchase loan product and a second purchase loan product, the demand volume model is run (i) for the first purchase loan product where the second purchase loan product is treated as a competing product and (ii) for second purchase loan product wherein the first purchase loan product is treated as a competing product.

In step 470, the previous steps (i.e., steps 410-460) may be repeated for a plurality of different prices, typically different interest rates, for the first purchase loan product to predict the demand volume of the first purchase loan product at each of the different prices. The combination of price and predicted volume of the first purchase loan product may then be employed by the first financial institution to determine the price at which to offer the first purchase loan product in the market.

In accordance with embodiments of the invention, the term “segment” is defined as a combination of a (i) financial product, (ii) a finance type used for the financial product, and (iii) an origination channel for the hypothetical customer. A financial product may be any product or instrument that is sold or marketed to customers of a financial institution designed to help a customer save, invest, get insurance, or get a mortgage. Examples of financial products include, but are not limited to, shares, bonds, options, mutual funds, certificates of deposit, annuities, bank accounts, savings accounts, insurance, loans, and mortgages.

For purposes of this invention relating to a first financial product, a competing financial product may be any financial product offered by a competing financial institution. For example, if Financial Institution A offers a first financial product, “Financial Product Y,” and Financial Institution B offers a first financial product, “Financial Product Y,” and a second financial product, “Financial Product Z,” then both financial products offered by Financial Institution B are considered competing financial products to Financial Institution A's offered Financial Product Y. Additionally, for purposes of this invention relating to a first financial product, a competing financial product may also be any financial product offered by the same financial institution, where the financial product offered by the same institution is different from the first financial product. For example, if Financial Institution A offers a first financial product, “Financial Product Y,” and a second financial product, “Financial Product Z,” then Financial Product Z is considered a competing financial product to Financial Product Y. As used herein, a financial product is a very specific kind of financial product, and is not as general as a loan, or a mortgage. For example, a 30 year fixed rate mortgage is a different financial product than a 15 year fixed rate mortgage.

A “finance type” is a method of payment used to acquire the financial product. A finance type may be any method used by customers of a financial institution to pay for the financial product, and includes, but is not limited to, purchase, refinance, cash-out refinance, rate-and-term refinance, term reduction (e.g., reducing a 30-year loan to a 15-year loan, and the like), second lien, credit purchase, finance through a security interest, and the like. The term “finance type” is not necessarily a reference to the type of financial product. For example, a first financial product that is a 10-year loan may have the same finance type as a second financial product that is a 15-year loan because both the first and second financial products are “purchase” products.

An “origination channel” is the manner in which a customer is offered, and may subsequently purchase, a financial product by a financial institution. Examples of origination channels include, but are not limited to, a centralized sales channel (e.g., call center), an electronic commerce channel, a distributed retail channel, and the like. Each combination of financial product type, finance type, and origination channel makes up a distinct segment. Each financial product has a demand volume based on the price of the financial product and the elements of the segment, whereby the demand volume may fluctuate across a range of potential price points for the financial product.

One aspect of the resulting demand volume for a financial product is a function based on the three elements of the segment. The financial institution may want to price segments differently, based on the three elements that make up each segment. For example, a first segment offered by a first financial institution may comprise a 10-year loan, financed through a refinance, and offered through an electronic commerce channel. A second segment offered by the same first institution may comprise a 10-year loan, financed through a refinance, and offered through a distributed retail channel. While the first and second segments may be somewhat similar, the first financial institution may apply a lower price (e.g., interest rate, amount of collateral, and the like) to the first segment based on the difference in origination channel if the electronic commerce channel is less expensive to maintain than the distributed retail center.

Variations in the pricing of each segment can affect the demand volume for the financial product for each segment. Therefore, a range of price points for a segment may be set. A price point is a hypothetical price for the financial product of the segment. In some embodiments, the range of price points for a segment is determined by a financial institution. In some embodiments, the range of price points is determined based on historical data. In some embodiments, the range of price points is derived from a database.

Cannibalization is the reduction in sales volume, sales revenue, and/or market share of one financial product, as a result of the introduction of, or the manipulation of the price of, a different financial product offered by the same financial institution. For example, reducing the price of a first financial product may significantly increase the demand of that first financial product. However, if the increased demand for the first financial product is caused by customers leaving a second financial product offered by the financial institution in search of the cheaper first financial product, then the lowered price of the first financial product may negatively impact the financial institution overall.

As used herein, the term “segment group” is defined as a set of segments which must be entered into a price point calculation simultaneously, rather than separately. In some embodiments, individual segments are combined into one segment group based on a business constraint. Additionally, individual segments may be combined into one segment group based on cannibalization.

As used herein, the term “objective function” refers to an algorithm that determines the ideal price point for a first financial product by calculating the price point times the demand volume for each price point within the range of available price points for the first financial product. The price point of the first financial product that produces the greatest revenue is determined by the objective function to be the ideal price point.

For purposes of this application, a first financial product may be any financial product offered by the first financial institution. The first financial product is part of a first segment. In some embodiments and in some examples, reference is made to a price point of the first financial product. This price point of the first financial product may be an available price point from a range of available price points for which to offer the first financial product within the first segment. In other words, a price point for the first financial product is a price that the first financial institution may offer to potential customers through the financing type and the origination channel of the first segment.

In general, any reference to a price of a segment may mean the price of a financial product that is part of that segment, as priced through the finance type and origination channel of that segment.

The general system for determining an ideal price point for a first financial product involves calculating a demand volume for the first financial product at a plurality of price points relative to one or more competing financial products, each with a range of possible price points. The ideal price point may be determined by the objective function. However, the competing financial products may include financial products owned or controlled by the first financial institution, and simply finding the price point for the first financial product that produces the most profit for the first financial institution may not be beneficial to the financial institution because of cannibalization between the first financial product and one or more competing financial products offered by the same financial institution. For example, lowering the price point of the first financial product may increase the demand volume of that product, but it may also decrease the demand volume of a second financial product offered by the same financial institution. In some cases, the decrease in demand volume for the second financial product may be more harmful to the profitability of the financial institution than the increase in demand for the first financial product, giving the financial institution a net loss.

In calculating the demand volume of a first financial product, there are several possible types of algorithms. First, a system may not group any of the segments together, and the demand volume is simply calculated for the first financial product across a range of available price points. The ideal price point of the first financial product is then determined by the objective function. This first algorithm has a fast computational time, and is not resource intensive. However, this first algorithm fails to account for the cannibalization or constraint relationships between segments, as described above. Therefore, this first algorithm lacks accuracy and, consequently, functionality.

A second type of algorithm may assume that all identified segments have a cannibalization relationship. In this second algorithm, the system calculates the demand volume of the first financial product for every single possible combination of price points among every segment. For example, a system that identifies 4 segments (S₁, S₂, S₃, and S₄). The system then identifies 10 price points for each segment (S₁₋₁, S₁₋₂, . . . S₁₋₁₀; S₂₋₁, S₂₋₂, . . . S₄₋₁₀). When determining the ideal price point for the first financial product (part of Segment 1 S₁), the system calculates the demand volume of the first financial product for every single possible combination of the four segments. As each of the 4 segments comprise 10 price points, the system must go through 10̂4 (10,000) iterations of the calculation. The objective function may then analyze the set of 10,000 results to determine the ideal price point of the first financial product. The second algorithm has a high computational cost because of the large number of calculations (10,000) and, consequently, computing time needed to determine the demand volume of the first financial product. However, this second algorithm has a high accuracy because of its exhaustive nature.

Finally, the system may use a third algorithm that harnesses the accuracy of the second, exhaustive, algorithm while reducing the high computational costs of the second algorithm. This third algorithm first analyzes the first segment with every other identified segment, one at a time, to determine whether the two segments are cannibalized or not. If the two segments are not cannibalized, then the system does not group the two segments together.

One method of determining if two segments are cannibalized, termed a cannibalization module, is to calculate the volume at each maximum and minimum price point combination for both segments, holding all other segments at their baseline values. The system may then calculate the difference in high-low volume when the two segments move together, and subtract that value from the high-low volume when the segments move separately. Next, the system may divide this difference by a baseline volume to get a cannibalization percentage. The system determines whether this cannibalization percentage is greater than a pre-set cannibalization tolerance level, and, if so, groups the two segments together. For example, in comparing the first segment S₁ (which includes the first financial product) with the second segment S₂, the system first identifies the minimum and maximum price points of the two segments (i.e., S₁₋₁ is the minimum price point of the first segment, S₁₋₁₀ is the maximum price point of the first segment, S₂₋₁ is the minimum price point of the second segment, and S₂₋₁₀ is the maximum price point of the second segment). The system then calculates the demand volume at each maximum and minimum price value of the two segments (i.e., a first demand volume V₁=demand volume at S₁₋₁₀ and S₂₋₁₀, a second demand volume V₂=demand volume at S₁₋₁ and S₂₋₁, a third demand volume V₃=demand volume at S₁₋₁₀ and S₂₋₁, and fourth demand volume V₄=demand volume at S₁₋₁ and S₂₋₁). The system then determines a first difference Δ₁ between the first demand volume V₁ and the second demand volume V₂ (i.e., Δ₁=|V₁−V₂|), and a second difference Δ₂ between the third demand volume V₃ and the fourth demand volume V₄ (i.e., Δ₂=|V₃−V₄|). The system then determines the difference between the first difference Δ₁ and the second difference Δ₂, and divides this result by a baseline volume to determine a cannibalization percentage Cₚₑᵣ.

As shown in the example, a system using the third algorithm only goes through 4 iterations of the demand volume calculation per segment pair, and the remaining calculations are simple arithmetic. In an example with four Segments (S₁, S₂, S₃, and S₄), the system only compares S₁ with S₂, S₁ with S₃, and S₁ with S₄, each comparison comprising only 4 iterations of the demand volume calculation. Therefore, the system runs a total of 12 iterations of the demand volume calculation in the cannibalization module step. In continuing the example, we shall assume, for illustrative purposes, that the system determined that the first segment S₁ is cannibalized with the second segment S₂ and the third segment S₃, but the first segment S₁ is not cannibalized with the fourth segment S₄. Therefore, the first, second, and third segments S₁, S₂, and S₃ are grouped together for future calculations while the fourth segment S₄ remains separated.

After comparing the first segment to the other, competing, segments, the system then runs an exhaustive algorithm similar to the second algorithm, for only the segments that are grouped together with the first segment (i.e., the segments that are considered “cannibalized” with the first segment). Continuing the earlier example for the third algorithm, the first, second, and third segments S₁, S₂, and S₃ each have 10 price points within their ranges of available price points. The system then calculates the demand volume of the first financial product for every single possible combination of these three segments. As each of the 3 segments comprise 10 price points, the system must go through 10̂3 (1,000) iterations of the calculation. The objective function may then analyze the set of 1,000 results to determine the ideal price point of the first financial product. Therefore, the total number of iterations of the demand volume calculation under the third algorithm equals 1,012: the 12 iterations from the cannibalization module and the 1,000 iterations from the full demand volume calculation of the group of segments.

This reduction in the total number of computations of the demand volume calculation is drastic compared to the second algorithm, as determining just one segment to not be cannibalized by the first segment reduced the overall number of iterations of the demand volume calculation by about an order of magnitude. In cases where many segments are compared, a single order of magnitude can significantly reduce the computation time of the system. Additionally, in cases where the system identifies several competing segments to be cannibalized with the first segment, the system effectively reduces the overall number of iterations of the demand volume calculation by several orders of magnitude, which may drastically reduce the computational time of the system. Such reductions in demand volume calculation iterations reduces the computational time and system resources, thus reducing the computational costs associated with the system.

Additionally, the system as described with the third algorithm does not significantly lose any accuracy because the segments not grouped with the first segment, and thus not involved in the overall demand volume calculation for the first segment, do not have a significant impact on the demand volume of the first financial product. Thus, the system retains the accuracy of an exhaustive algorithm while significantly reducing the computational costs associated with such an exhaustive algorithm.

Therefore, to generate a more useful demand volume calculation, the system described below uses a dynamic cannibalization module to identify which segments cannibalize each other, and therefore should be grouped together for purposes of calculating the demand volume of the first financial product.

In order to predict the demand for a first loan refinancing product, the system and method in accordance with the present invention typically simulate the decision making process for each of a plurality of hypothetical customers. More particularly, the likelihood of each hypothetical customer choosing between the first financial product and one or more competing financial products is typically simulated. The likelihood of a hypothetical customer choosing a particular financing product is based upon principles as described herein.

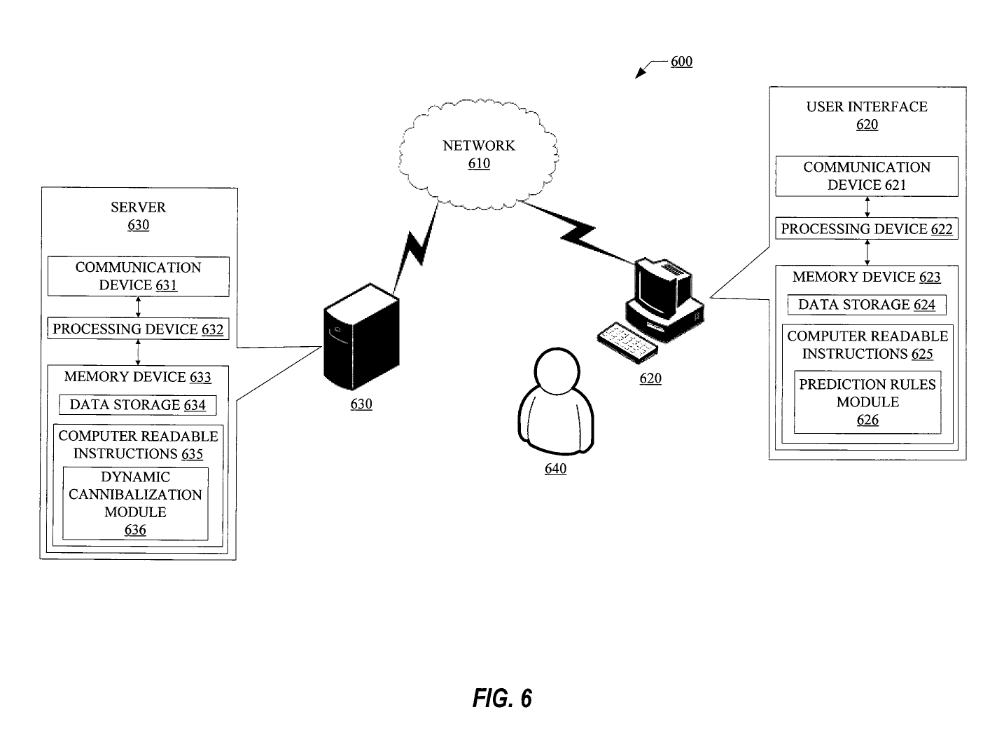

FIG. 6 illustrates a system 600 for reducing computational costs associated with predicting demand for products by a first financial institution, in accordance with an embodiment of the present invention. As illustrated, the system 600 may include a network 610, a user interface 620, and a server 630. In one embodiment, a user 640 may be associated with the user interface 620. Typically, such users 640 are technical personnel tasked with managing the demand and pricing of products associated with a financial institution. As illustrated, the user interface 620 and the server 630 each include a communication device 621 and 631, a processing device 622 and 632, a memory device 623 and 633, a data storage 624 and 634, and computer readable instructions 625 and 635.

As used with respect to the user interface 620 and the server 630, a “communication device” 621 and 631 may generally include a modem, server, transceiver, and/or other device for communicating with other devices on a network. A “processing device” 622 and 632 may generally refer to a device or combination of devices having circuitry used for implementing the communication and/or logic functions of a particular system. For example, a processing device 622 and 632 may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more programs based on computer-executable program code thereof, which may be stored in a memory device 623, 633. As the phrase is used herein, a processing device may be “configured to” perform a certain function in a variety of ways, including, for example, particular computer-executable program code embodied in a computer-readable medium, and/or by having one or more application-specific circuits perform the function. The processing device 622 and 632 may be configured to use the communication device 621 and 631 to transmit and/or receive data and/or commands to and/or from other devices within the network 610.

A “memory device” 623 and 633 may generally refer to a device or combination of devices that store one or more forms of computer-readable media for storing data and/or computer-executable program code/instructions. For example, in one embodiment, the memory device 623, 633 may include any computer memory that provides an actual or virtual space to temporarily or permanently store data and/or commands provided to the processing device 622, 632 when it carries out its functions described herein. In one embodiment, the memory device 623 of the user interface 620 includes computer readable instructions 625 that include a prediction rules module 626 discussed more fully below. Furthermore, the memory device 633 of the server 630 may include computer readable instructions 635 that include a dynamic cannibalization module discussed more fully below. Additionally, in some embodiments, the memory device 623, 633 includes a data storage 624, 634 or database configured for storing information and/or data. In other embodiments, the data storage 624, 634 may be housed remotely from the user interface 620 and the server 630, and the user interface 620 and the server 630 are in communication with the data storage 624, 634 across the network 610 and/or across some other communication link.

The network 610 may include a local area network (LAN), a wide area network (WAN), and/or a global area network (GAN). The network 610 may provide for wireline, wireless, or a combination of wireline and wireless communication between devices in the network. In some embodiments, the network 610 includes a wireless telephone network. In some embodiments, the network includes the Internet. In some embodiments, the network 610 includes an intranet. Furthermore, the network 610 may include a combination of an intranet and the Internet.

The prediction rules module 626 may be a plurality of rules for determining how each hypothetical shopping customer makes a financial product decision. In some embodiments, the prediction rules module 626 may be substantially similar to the prediction rules module 240 illustrated in FIG. 2. In some embodiments, the prediction rules module 626 may be substantially similar to the prediction rules module 540 illustrated in FIG. 5.

The dynamic cannibalization module 636 may establish a minimum cannibalization tolerance level; pair two of the plurality of segments together; determine a cannibalization percentage for the two segments; determine that the cannibalization percentage is greater than the minimum cannibalization tolerance level; and group the segments together for all subsequent analysis. The dynamic cannibalization module 636 may also monitor databases accessible by the network 610 to determine if information relevant to the cannibalization analysis has changed for one or more segments. As such, the dynamic cannibalization module 636 may update the cannibalization analysis (and segment grouping) whenever changes are discovered, on a periodic or real-time basis.

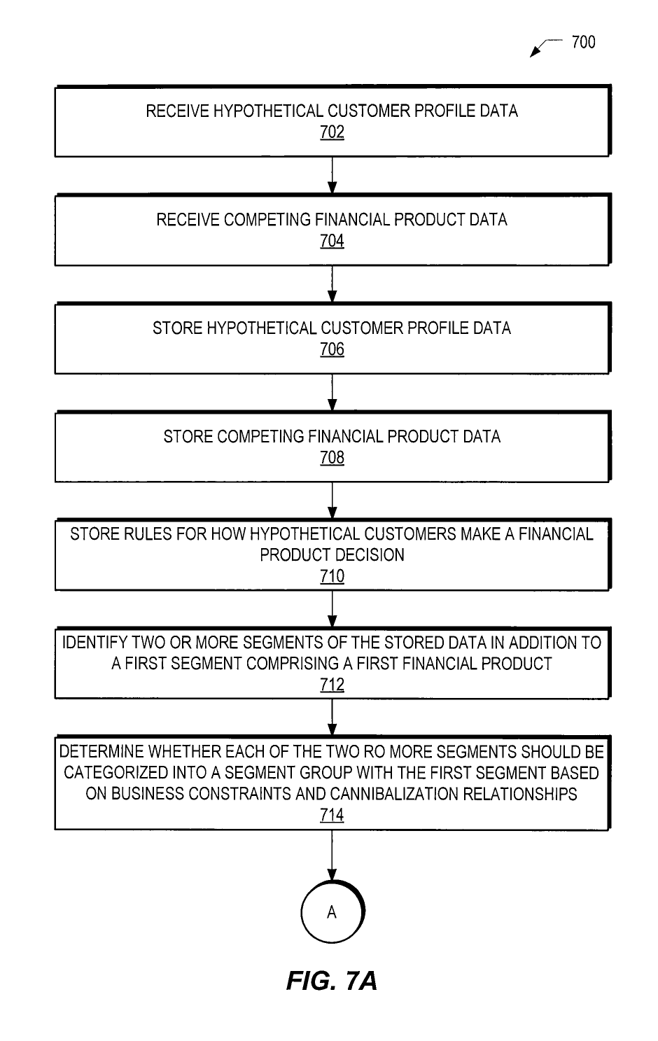

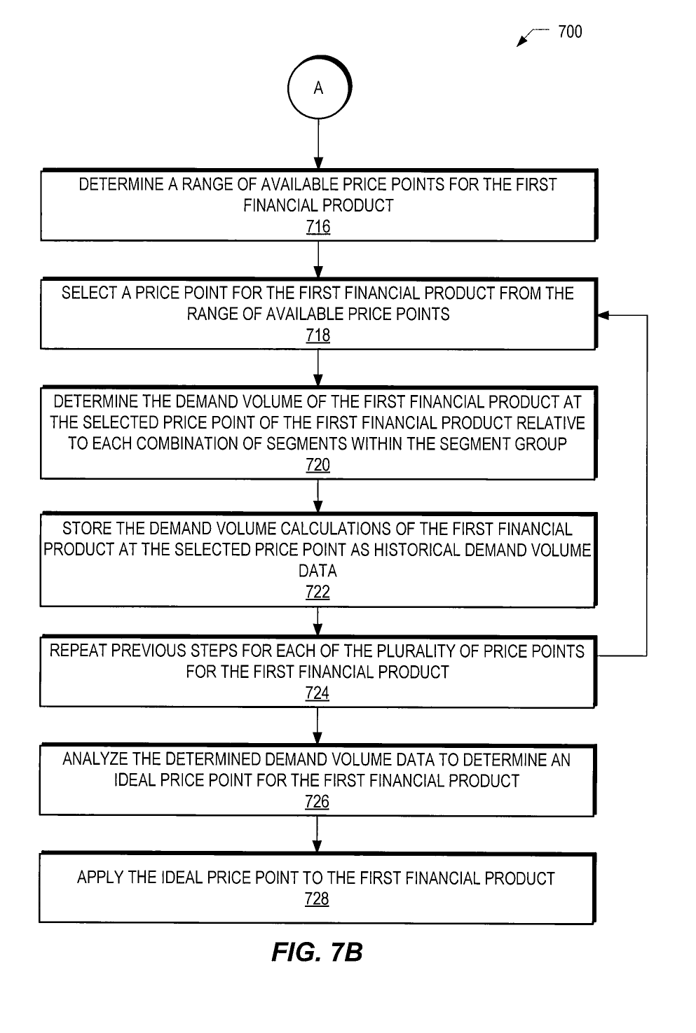

FIGS. 7A and 7B illustrate a process flow 700 of a system for reducing computational costs associated with predicting demand for products by a first financial institution in accordance with one aspect of the present invention. As illustrated in block 702, the system receives hypothetical customer profile data. The hypothetical customers reflect the makeup of customers expected to be shopping for financial products during a predetermined period of time (e.g., a week, a month, or a year). In other words, the hypothetical customers when aggregated should reflect the makeup of expected shopping customers (e.g., in terms of financial makeup). Accordingly, the makeup of the hypothetical customers may be based upon various factors including the expected size of the market for financial products (e.g., based upon historical market size data from the past week or month) and the expected financial makeup (e.g., expected loan amount, current income, credit score, current loan-to-value ratio, and maximum acceptable debt-to-income ratio) of the customers. In this regard, the distribution of maximum acceptable debt-to-income ratios of the hypothetical customers should reflect the distribution of the debt-to-income ratios of customers who purchased financial products as found in recent historical data (e.g., from the previous month). In one embodiment, the distribution of maximum acceptable debt-to-income ratios for the hypothetical customers may vary by geographic region. For example, the hypothetical customers may, on average, have higher maximum acceptable debt-to-income ratios in geographic regions having a lower cost of living. In one embodiment, the total number of hypothetical customers is equal to the expected total number of shopping customers, where the expected total number of shopping customers may be based upon various factors including the expected size of the market for financial products (e.g., based upon historical market size data from the past week or month). In an alternative embodiment, the hypothetical customers are a representative sample of the expected total number of shopping customers.

In some embodiments, the hypothetical customer profile is the same hypothetical customer profile described in FIG. 1. In some embodiments, the hypothetical customer profile is the same hypothetical customer profile described in FIG. 4.

As illustrated in block 704, the system receives competing financial product data. The competing financial products reflect the makeup of competing financial products expected to be available (e.g., available to the hypothetical customers) during the predetermined period of time. In other words, the hypothetical competing financial products when aggregated should reflect the makeup of expected competing financial products. Accordingly, the makeup of the hypothetical competing financial products may be based upon recent (e.g., from the past week or month) competitor price data. Each competing financial product profile includes a rate reflecting a loan rate of a competing financial product.

As mentioned before, a financial product may be any product or instrument that is sold or marketed to customers of a financial institution designed to help a customer save, invest, get insurance, or get a mortgage. Examples of financial products include, but are not limited to, shares, bonds, options, mutual funds, certificates of deposit, annuities, bank accounts, savings accounts, insurance, loans, and mortgages.

Financial product data may be any data associated with a financial product, the finance type offered with the financial product, the origination channel within which the financial product is marketed, and any other information related to how a financial institution markets, offers, finances, and generally provides a financial product.

As illustrated in block 706, the system stores the hypothetical customer profile data. In some embodiments, the hypothetical customer profile data is stored in a data storage 624, 634. The hypothetical customer profile data may be stored in such a way as to allow a processing device 622, 632, to execute computer readable instructions 625, 635, for accessing the hypothetical customer profile data. In some embodiments, a communication device 621, 631 may access the hypothetical customer profile data by accessing a data storage 624, 634, across the network 610.

As illustrated in block 708, the system stores the competing customer product data. In some embodiments, the competing financial product data is stored in a data storage 624, 634. The competing financial product data may be stored in such a way as to allow a processing device 622, 632, to execute computer readable instructions 625, 635, for accessing the competing financial product data. In some embodiments, a communication device 621, 631 may access the competing financial product data by accessing a data storage 624, 634, across the network 610.

As illustrated in block 710, the system stores rules for how hypothetical customers make a financial product decision (e.g., in a prediction rules module 626). These rules typically include (i) rules for determining whether each hypothetical shopping customer will decide to purchase a financial product and (ii) rules for determining which financial product each hypothetical shopping customer will decide to purchase (e.g., choosing from the first financial product and a competing financial product).

For example, the rules may be a plurality of rules for determining how each hypothetical shopping customer makes a loan refinancing decision. These rules typically include (i) rules for determining whether each hypothetical shopping customer will decide to purchase a loan refinancing product and (ii) rules for determining which loan refinancing product each hypothetical shopping customer will decide to purchase (e.g., choosing from the first loan refinancing product and the hypothetical competing loan refinancing products). In some embodiments, the prediction rules module 626 may be substantially similar to the prediction rule module 240 illustrated in FIG. 2.

For example, in other embodiments, the prediction rules module 626 may include a plurality of rules for determining how each hypothetical shopping customer makes a purchase loan decision. These rules typically include (i) rules for determining whether each hypothetical shopping customer will decide to purchase a purchase loan product and (ii) rules for determining which purchase loan product each hypothetical shopping customer will decide to purchase (e.g., choosing from the first purchase loan product and the hypothetical competing purchase loan products). In some embodiments, the prediction rules module 626 may be substantially similar to the prediction rule module 540 illustrated in FIG. 5.

As illustrated in block 712, the system identifies two or more segments of the stored data in addition to a first segment comprising a first financial product. As previously mentioned, a segment is a combination of a (i) financial product, (ii) a finance type used for the financial product, and (iii) an origination channel for the hypothetical customer. Each varied combination of a financial product, a finance type, and an origination channel is a separate and distinct segment. For example, “Segment ABC” comprising “Financial Product A,” “Finance Type B,” and “Origination Channel C” is a different segment from “Segment ABD,” comprising “Financial Product A,” “Finance Type B,” and “Origination Channel D.”

As illustrated in block 714, the system determines whether each of the two or more segments should be categorized into a segment group with the first segment based on business constraints and cannibalization relationships. The system may first groups segments into the segment group based on business constraints. Business constraints are rules of the financial institution, or the business enterprise of the financial institution in general, that make comparing two segments (or the financial products within those segments) redundant, impractical, or impossible. For example, customers that are qualified for purchasing Financial Product A may never be qualified for purchasing Financial Product B, based on an income level, a geographic location of the customers, or some other restricting element. As such, Financial Product A and Product B would not be grouped together. However, if Financial Product A and Financial Product B are the same type of financial product, just offered by different financial institutions, then Financial Product A and Financial Product B may be grouped together.

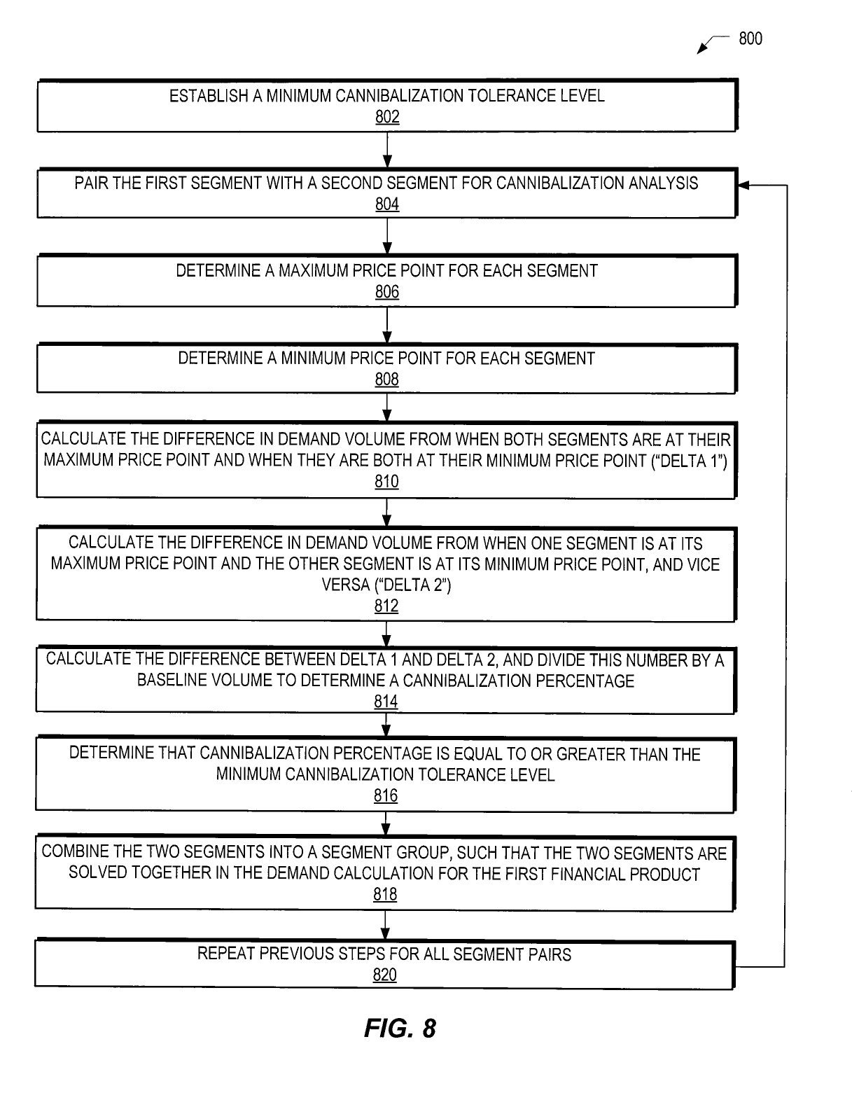

The system then groups segments into segment groups based on cannibalization by using the dynamic cannibalization module described in FIG. 8. By grouping segments based on business constraints first, the system prevents unnecessary and redundant calculations in the dynamic cannibalization module. Additionally, the business constraint analysis may determine that two segments cannot be grouped together because of a business constraint. In such cases, the dynamic cannibalization module would not analyze the two segments.

In some embodiments, the act of grouping two or more segments together comprises organizing the two or more segments into a single set of segments (the segment group) which must be entered into a price point calculation simultaneously, rather than separately.

The groups of segments based on business constraints may be referred to as “business groups.” The groups of segments based on cannibalization may be referred to as “cannibalization groups. In cases where the first segment, comprising the first financial product, is both associated with one or more competing segments in a business group and associated with one or more competing segments in a cannibalization group, the two groups may be combined into a single segment group for future calculations. Ultimately, the demand volume calculations for the first financial product will comprise a single segment group that comprises every competing segment that has been grouped together with the first segment.

As illustrated in block 716, the system determines a range of available price points for the first financial product. The range of available price points for the first financial product includes a minimum price point, a maximum price point, and a plurality of price points between the minimum and maximum price point. In later steps, the system will analyze the demand volume of the first financial product at each price point throughout the range of available price points. As the general goal for setting an offered price for a financial product is to maximize the product of price times demand volume, the use of more price points in the system's financial product analysis increases the precision of the system. For example, a range that includes 200 price points (or “basis points”) will produce a more precise ideal price point than a range of 100 price points. Of course, the number of price points in the range can be smaller to reduce computation time, and thus reduce computational costs. In one embodiment, the system contains N price points.

In some embodiments, the determination of the range of available price points comprises identifying price “windows” for each segment, wherein a window is a restrictive range of prices based on business information. For example, if the financial institution has a rule that Financial Product A must cost more than Financial Product B, then the segments comprising Financial Product A as the financial product must have a minimum price point that is greater than the maximum price point of segments comprising Financial Product B.

As illustrated in block 718, the system selects a price point for the first financial product from the range of available price points. In some embodiments, the selected price point may be the lowest price point, the highest price point, or a random price point. In some embodiments of the invention, the step in block 718 is repeated multiple times, and in the first iteration of the step in block 718, the system selects the lowest price point from the range of available price points. In such an embodiment, the system may select the second lowest price point during the second iteration of block 718. Continuing the example, the selected price point increases until the system selects the highest, or maximum, price point from the range of available price points.

As illustrated in block 720, the system determines the demand volume of the first financial product at the selected price point of the first financial product relative to each combination of segments within the segment group. In general, the system calculates whether it is likely that the financial product will be purchased by each of the plurality of hypothetical customers, according to the rules for each of those hypothetical customers and the plurality of segments available, and then scales the calculation to match an expected shopping customer (not hypothetical) volume. In some embodiments, the demand volume of the first financial product is determined in the same manner as illustrated in FIG. 1 and explained previously. In some embodiments, the demand volume of the first financial product is determined in the same manner as illustrated in FIG. 4 and explained previously. In general, the factors used in determining the demand volume of a financial product include, but are not limited to, the maximum acceptable cost of the first financial product for the customer, the ratio of the total number of expected shopping customers over the total number of hypothetical shopping customers, the loan rate of the first financial product, the expected cost of the first financial product for the hypothetical customer, and the expected cost of the competing financial product.

As illustrated in block 722, the system stores the demand volume calculations of the first financial product at the selected price point as determined demand volume data. In some embodiments, the determined demand volume data is stored in a data storage 624, 634. The determined demand volume data may be stored in such a way as to allow a processing device 622, 632, to execute computer readable instructions 625, 635, for accessing the determined demand volume data. In some embodiments, a communication device 621, 631, may access the determined demand volume data by accessing a data storage 624, 634, across the network 610.

As illustrated in block 724, the system repeats the previous steps represented in blocks 718 through 722 for each of the plurality of price points for the first financial product.

As illustrated in block 726, the system analyzes the determined demand volume data to determine an ideal price point for the first financial product. In some embodiments, the ideal price point is the highest product of price point times demand volume. In some embodiments, the ideal price point is the tested price point that produces the highest demand volume, regardless of the amount of the tested price point. For example, a financial institution may place more value obtaining a greater market share for their first financial product than in making the most profit from the first financial product's sale.

In some embodiments, the system calls an objective function to determine the ideal price point of the first financial product. The objective function may calculate the expected volume times the revenue per unit of demand volume to determine the revenue of each price point of the first financial product. The objective function may then determine the ideal price point of the first financial product to be the price point of the first financial product that is associated with the highest revenue value.

Finally, as illustrated in block 728, the system applies the ideal price point to the first financial product. The first financial institution may market the first financial product at the determined financial product in the real market. For example, the first financial institution may offer the first financial product at the determined ideal price point, through the finance type and origination channel of the first segment.

FIG. 8 illustrates a process flow 800 of a dynamic cannibalization module, in accordance with one embodiment of the invention. As illustrated in block 802, the system establishes a minimum cannibalization tolerance. As mentioned before, cannibalization is the reduction in sales volume, sales revenue, and/or market share of one financial product, as a result of the introduction of, or the manipulation of the price of, a different financial product. As the cannibalization module tests to determine whether two segments cannibalize each other, a cannibalization tolerance level is required to establish an amount of cannibalization deemed necessary to justify grouping the two segments together.

In some embodiments, cannibalization between two segments is judged on a percentage basis. In such an embodiment, the minimum cannibalization tolerance level is represented as a percentage. For example, the minimum cannibalization tolerance level may be X %, and any two segments that are determined to have a cannibalization percentage of X % or greater will be considered cannibalized and grouped together in future stages of the system.

In some embodiments, cannibalization between two segments is judged on a demand volume quantity basis. In such an embodiment, the minimum cannibalization tolerance level is represented as a number of customers predicted to be lost by the financial institution due to cannibalization of the two segments. For example, the minimum cannibalization tolerance level may be “Y customers,” and any two segments that are determined to have a cannibalization tolerance number of Y customers or greater will be considered cannibalized and grouped together in future stages of the system.

The smaller the cannibalization tolerance level, the more likely it is that more segments will be considered “cannibalized.” However, cannibalizing (and thus grouping) all segment pairs defeats the purpose of cannibalizing some segments to reduce redundancies and computational costs associated with determining an ideal price point for a first financial product. Therefore, a minimum cannibalization tolerance level that is large enough to be effective, yet small enough to beneficially group cannibalized segments together and reduce computational costs associated with the system is typically employed. In some embodiments, the cannibalization tolerance level is determined by the financial institution. In some embodiments, the cannibalization tolerance level is determined based on historical data associated with the dynamic cannibalization module, the financial institution, and/or the first financial product.

As illustrated in block 804, the system pairs a firsts segment with a second segment for cannibalization analysis. In some embodiments, the first segment comprises the first financial product and the second segment comprises at least a different financial product, a different finance type or a different origination channel.

As illustrated in block 806, the system determines a maximum price point for each segment. The maximum price point for each segment is the maximum price for which the offering financial institution is willing to offer the financial product, based on the financing type and origination channel of that segment. In some embodiments, the maximum price point for each segment is determined or set by the financial institution. In some embodiments, the maximum price point for each segment is based on historical data associated with the offered price of the financial product.

As illustrated in block 808, the system determines a minimum price point for each segment. The minimum price point for each segment is the minimum price for which the financial institution is willing to offer the financial product to customers, based on the financing type and origination channel of that segment. In some embodiments, the minimum price point for each segment is determined or set by the financial institution. In some embodiments, the minimum price point for each segment is based on historical data associated with the offered price of the financial product.

As illustrated in block 810, the system calculates the difference in demand volume of the first financial product from when both segments are at their maximum price point and when they are both at their minimum price point. As described, the system runs a first demand volume analysis based on when the two segments are each at their maximum price point (denoted as “V₁”). To further clarify, the first demand volume V₁ is the calculated demand volume of the first financial product for the financial products of the first and second segments when such financial products of the segments are priced at their minimum price point. The system then runs a second demand volume analysis based on when the two segments are each at their minimum price points (denoted as “V₂”). To further clarify, the second demand volume V₂ is the calculated demand volume of the first financial product for the financial products of the first and second segments when such financial products of the segments are priced at their maximum price point. The system then calculates the difference between V₁ and V₂, and stores the result as Δ₁.

As illustrated in block 812, the system calculates the difference in demand volume of the first financial product from when one segment is at its maximum price point and the other segment is at its minimum price point, and vice versa. As described, the system runs a third demand volume analysis based on when the first segment is at its maximum price point and when the second segment is at its minimum price point (denoted as “V₃”). To further clarify, the third demand volume V₃ is the calculated demand volume for the first financial product of the first and second segments when the financial product of the first segment is priced at its maximum price point and the financial product of the second segment is priced at its minimum price point. The system then runs a fourth demand volume based on when the first segment is at its minimum price point and when the second segment is at its maximum price point (denoted as “V₄”). To further clarify, the fourth demand volume V₄ is the calculated demand volume for the first financial product when the financial product of the first segment is priced at its minimum price point and the financial product of the second segment is priced at its maximum price point. The system then calculates the difference between the third demand volume V₃ and the fourth demand volume V₄, and stores the result as a second difference Δ₂.

As illustrated in block 814, the system calculates the difference in the calculated differences of block 810 and block 812, then divides the resulting number by a baseline volume to determine a cannibalization percentage. As described, the system determines the difference between the first difference Δ₁ and the second difference Δ₂, then divides the result by the baseline volume V_{base} to calculate the cannibalization percentage Cₚₑᵣ:

$${C}_{per} = \frac{\vert {Δ}_{1} - {Δ}_{2} \vert}{{V}_{base}} \times 100$$

In some embodiments, the baseline volume V_{base} is equal to the calculated demand volume at the current price points of the two segments. In some embodiments, the baseline volume V_{base} is equal to the minimum value of V₁, V₂, V₃, and V₄. In some embodiments, the baseline volume V_{base} is equal to the maximum value of V₁, V₂, V₃, and V₄. In some embodiments, the baseline volume V_{base} is equal to the average value of V₁, V₂, V₃, and V₄. In other embodiments, the baseline volume V_{base} is some other value identified or determined by the financial institution. In some embodiments, the baseline volume V_{base} is the volume of the first financial product over some point in time in the past. For example, the baseline volume V_{base} may be the volume of the first financial product over the past week. In some embodiments, the baseline volume V_{base} may be a volume quantity based on an average, median, mode, or other statistical characteristic of the first, second, third, and/or fourth demand volumes V₁, V₂, V₃, and/or V₄.

As illustrated in block 816, the system determines that the cannibalization percentage is equal to or greater than the minimum tolerance level. The system compares the cannibalization percentage Cₚₑᵣ to the minimum tolerance level established in block 802. If the cannibalization percentage Cₚₑᵣ is greater than the minimum tolerance level, then the system treats the two segments as cannibalized.

If the system determines that the cannibalization percentage is less than the minimum tolerance level, then the system keeps the two systems separated for the ideal price point calculation for the first financial product. Additionally, the system may store information about the separate and non-cannibalized nature of the two segments in a network database.

As illustrated in block 818, the system combines the two segments into a segment group, such that the two segments are solved together in the demand calculation for the first financial product. The system may store relationship information about whether the two segments are grouped in a database.

By only grouping two segments together when the system identifies a cannibalization relationship between the two segments, the system reduces the number of segments that are actually entered into the exhaustive algorithm of calculations for the demand volume of the first financial product. Consolidating the number of segments entered into the ideal price point calculation for a first financial product to only a set of segments that do cannibalize each other allows the system to significantly cut down on the number of computations required to determine the ideal price point of a first financial product. In some embodiments, the ideal price point calculation is an exhaustive algorithm that tests every possible configuration of segments (as variables) that are grouped together, so the removal of each segment reduces the total number of computations by an order of magnitude. Such drastic reductions in the quantity of computations in turn reduces the time, energy, and overall cost of the system.

Additionally, this system that produces a substantial reduction in computational costs does not significantly reduce the accuracy of the overall analysis of demand volume calculations or the subsequent determination of an ideal price point for the first financial product. The system only groups together and analyze segments that are cannibalized or linked through business constraints with the first segment. In other words, the only segments that are used as variables in the demand volume calculation of the first financial product are segments that have been determined to actually affect the demand volume of the first financial product as the price point of those segments changes. Segments that are not grouped due to a lack of cannibalization or due to business constraints may not be used as variables in the demand volume calculations of the first financial product because such price changes within such segments would not have a significant effect on the first financial product's demand volume. Therefore, leaving these non-grouped segments out of the demand volume calculations of the first financial product does not significantly affect the accuracy of the system, when compared to a purely exhaustive algorithm system that treats every single segment as a variable in the demand volume calculations of the first financial product.

Finally, as illustrated in block 820, the system repeats the previous steps represented in blocks 804 through 818 until the first segment has been compared with each segment. As such, the system may aggregate each segment that is cannibalized with the first segment (and therefore the first financial product), into one large segment group for subsequent calculations. For example, the system may only use the segments stored in the segment group for the calculations of the demand volume of the first financial product described in FIG. 7.

By repeating the steps represented in blocks 804 through 818, the system determines which segments cannibalize each other, and which segments do not cannibalize each other, thus reducing the total number of segments to be used in the ideal price point calculation for a first financial product to the greatest possible number of segments that actually do cannibalize each other. The system thereby eliminates redundancies and unnecessary computations in the overall calculation process. As mentioned before, the computational costs associated with the exhaustive algorithm method of calculating the ideal price point for the first financial product is significantly reduced by limiting the number of segments to this greatest cannibalized number. Additionally, the system may combine the segments grouped with the first segment through the cannibalization analysis with the segments grouped with the first segment through business constraints to further reduce the number of segments involved in the demand volume calculations of the first financial product. The system saves time and computational resources of the overall calculation, freeing up such time and resources for other tasks, and improving an overall efficiency for the financial institution.

In some embodiments, the dynamic cannibalization module illustrated in FIG. 8 is executed every time the system calculates the ideal price point of a first financial product. In other embodiments, the system monitors the elements of the segment (e.g., the system may monitor competitor prices, national interest rates, and the like) and only executes the dynamic cannibalization module for segments that have changed in their range of price points. In such an embodiment, the system does not repeat previously executed cannibalization analysis on segments when an identical cannibalization analysis has previously been executed. Instead, the system may pull stored cannibalization relationship information for the two segments from one or more databases and use this information to determine whether the two segments will be grouped together or kept separate in the ideal price point calculation for a financial product.

In some embodiments, the system executes a single dynamic cannibalization module analysis for every segment on a periodic basis (i.e., weekly, monthly, and the like). In such embodiments, the system stores the cannibalization relationship information for each segment pair and pulls this information for every ideal price point calculation for a financial product during the remainder of the period. As such, the system may have a relatively high computational cost for the initial execution of the dynamic cannibalization module, but the computational cost for the subsequent ideal price point calculations for a financial product are significantly lower than running an exhaustive algorithm for every segment (without cannibalization analysis) for each financial product.

In some embodiments, the system continuously monitors databases accessible to the network 610 and provides updated cannibalization analysis upon identifying a change to financial product pricing for one or more segments. As such, the dynamic cannibalization module provides real-time or near real-time analysis and feedback of cannibalization relationships between segments. As mentioned before, the system may provide analysis in real-time and then store the cannibalization relationship information in databases that are easily accessible to the system. Thus, whenever the system calculates an ideal price point for a financial institution, the system may easily access accurate, up-to-date, cannibalization information for each segment and bypass the costly computational costs previously discussed.

As will be appreciated by one of skill in the art, the present invention may be embodied as a method (including, for example, a computer-implemented process, a business process, and/or any other process) or an apparatus (including, for example, a system, machine, device, computer program product, and/or the like). Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for reducing computational costs associated with predicting demand for a first financial product, said system comprising:
a computing platform comprising one or more processing devices and executable software code stored in one or more electronic storage devices, wherein the executable software code is configured to cause the one or more processing devices to:
receive hypothetical customer profile data for a plurality of hypothetical customers;
receive competing financial product data for a plurality of competing financial products, wherein the competing financial products comprise the first financial product and at least one other financial product that competes with the first financial product, and wherein the competing financial product data comprises at least a competing financial product, one or more financing types associated with each competing financial product, and one or more origination channels associated with each competing financial product;
store hypothetical customer profile data in one or more network databases;
store competing financial product data in one or more network databases;
store a plurality of rules for how hypothetical customers make a financial product decision in one or more network databases;
identify two or more segments for the competing financial products from the stored competing financial product data, wherein the segments comprise a first financial product segment, and wherein each of the segments comprises a combination of the following:
one of the competing financial products;
one of the one or more financing types associated with the one of the competing financial products; and
one of the one or more origination channels associated with the one of the competing financial products;
execute a dynamic cannibalization module, wherein the dynamic cannibalization module is configured to cause the one or more processing devices to:
establish a minimum cannibalization tolerance level;
pair the first financial product segment with one other segment of the segments, wherein the first segment comprises the first financial product;
determine a minimum price point for each of the first financial product segment and the other segment;
determine a maximum price point for each of the first financial product segment and the other segment;
calculate a first difference Δ₁, wherein the first difference Δ₁ is the difference between a first demand volume of the first financial product segment from when both of the first financial product segment and the other segment are at their maximum price points and a second demand volume of the first financial product segment from when both of the first financial product segment and the other segment are at their minimum price points;
calculate a second difference Δ₂, wherein the second difference Δ₂ is the difference in a third demand volume of the first financial product segment from when the first financial product segment is at its maximum price point and the other segment is at its minimum price point, and a fourth demand volume of the first financial product segment from when the first financial product segment is at its minimum price point and the other segment is at its maximum price point;
calculate a cannibalization percentage Cₚₑᵣ, wherein the cannibalization percentage Cₚₑᵣ is the difference between the first difference Δ₁ and the second difference Δ₂, divided by a baseline volume V_{base};
determine if the cannibalization percentage is equal to or greater than the minimum cannibalization tolerance level;
if the cannibalization percentage is equal to or greater than the minimum cannibalization tolerance level, then combine the first financial product segment and the other segment into a first segment group; and
repeat the steps “pair the first financial product segment . . . ” through “combine the first financial product segment and the other segment . . . ” for all other segments of the segments; and
determine an ideal price point for the first financial product segment based on the first segment group.

2. The system of claim 1, wherein the executable software code is further configured to cause the one or more processing devices to:
determine a plurality of available price points for the first financial product segment;
select a first price point for the first financial product from the plurality of available price points;
determine a demand volume of the first financial product segment at the selected price point, wherein the demand volume of the first financial product segment is calculated based on an exhaustive algorithm that analyzes the demand volume of the first financial product segment for each combination of a plurality of price points for the one or more segments of the segment group;
store the determined demand volume of the first financial product segment at the selected price point;
repeat steps from “select a first price point . . . ” to “store the calculated demand volume . . . ” for each price point of the plurality of available price points for the first financial product segment; and
determine an ideal price point for the first financial product segment based on the determined demand volume data.

3. The system of claim 2, wherein the executable software code is further configured to cause the one or more processing devices to apply the ideal price point to the first financial product segment.

4. The system of claim 1, wherein the executable software code is further configured to:
monitor one or more network databases for changes to the hypothetical customer profile data and the competing financial product data;
determine that one of the hypothetical customer profile data or the competing financial product data has changed; and
update the one or more network databases associated with the hypothetical customer profile data or the competing financial product data with the changed data.

5. The system of claim 1, wherein the first financial product is a loan refinancing product.

6. The system of claim 1, wherein the first financial product is a purchase loan product.

7. A computer implemented method for reducing computational costs associated with predicting demand for a first financial product, said computer implemented method comprising:
providing a computing system within a distributive network for reducing computational costs associated with predicting demand for a first financial product, comprising a computer processing device and a non-transitory computer readable medium, where the computer readable medium comprises configured computer program instruction code, such that when said instruction code is operated by said computer processing device, said computer processing device performs the following operations:
receiving hypothetical customer profile data for a plurality of hypothetical customers;
receiving competing financial product data for a plurality of competing financial products, wherein the competing financial products comprise the first financial product and at least one other financial product that competes with the first financial product, and wherein the competing financial product data comprises at least a competing financial product, one or more financing types associated with each competing financial product, and one or more origination channels associated with each competing financial product;
storing hypothetical customer profile data in one or more network databases;
storing competing financial product data in one or more network databases;
storing a plurality of rules for how hypothetical customers make a financial product decision in one or more network databases;
identifying two or more segments for the competing financial products from the stored competing financial product data, wherein the segments comprise a first financial product segment, and wherein each of the segments comprises a combination of the following:
one of the competing financial products;
one of the one or more financing types associated with the one of the competing financial products; and
one of the one or more origination channels associated with the one of the competing financial products;
executing a dynamic cannibalization module, wherein the dynamic cannibalization module is configured to cause the one or more processing devices to:
establish a minimum cannibalization tolerance level;
pair the first financial product segment with one other segment of the segments, wherein the first segment comprises the first financial product;
determine a minimum price point for each of the first financial product segment and the other segment;
determine a maximum price point for each of the first financial product segment and the other segment;
calculate a first difference Δ₁, wherein the first difference Δ₁ is the difference between a first demand volume of the first financial product segment from when both of the first financial product segment and the other segment are at their maximum price points and a second demand volume of the first financial product segment from when both of the first financial product segment and the other segment are at their minimum price points;
calculate a second difference Δ₂, wherein the second difference Δ₂ is the difference in a third demand volume of the first financial product segment from when the first financial product segment is at its maximum price point and the other segment is at its minimum price point, and a fourth demand volume of the first financial product segment from when the first financial product segment is at its minimum price point and the other segment is at its maximum price point;
calculate a cannibalization percentage Cₚₑᵣ, wherein the cannibalization percentage Cₚₑᵣ is the difference between the first difference Δ₁ and the second difference Δ₂, divided by a baseline volume V_{base};
determine if the cannibalization percentage is equal to or greater than the minimum cannibalization tolerance level;
if the cannibalization percentage is equal to or greater than the minimum cannibalization tolerance level, then combine the first financial product segment and the other segment into a first segment group; and
repeat the steps “pair the first financial product segment . . . ” through “combine the first financial product segment and the other segment . . . ” for all other segments of the segments; and
determining an ideal price point for the first financial product based on the first segment group.

8. The computer implemented method of claim 7, further comprising:
determining a plurality of available price points for the first financial product segment;
selecting a first price point for the first financial product from the plurality of available price points;
determining a demand volume of the first financial product segment at the selected price point, wherein the demand volume of the first financial product segment is calculated based on an exhaustive algorithm that analyzes the demand volume of the first financial product segment for each combination of a plurality of price points for the one or more segments of the segment group;
storing the determined demand volume of the first financial product segment at the selected price point;
repeating steps from “select a first price point . . . ” to “store the calculated demand volume . . . ” for each price point of the plurality of available price points for the first financial product segment; and
determining an ideal price point for the first financial product segment based on the determined demand volume data.

9. The computer implemented method of claim 8, further comprising:
applying the ideal price point to the first financial product segment.

10. The computer implemented method of claim 7, further comprising:
monitoring one or more network databases for changes to the hypothetical customer profile data and the competing financial product data;
determining that one of the hypothetical customer profile data or the competing financial product data has changed; and
updating the one or more network databases associated with the hypothetical customer profile data or the competing financial product data with the changed data.

11. The computer implemented method of claim 7, wherein the first financial product is a loan refinancing product.

12. The computer implemented method of claim 7, wherein the first financial product is a purchase loan product.

13. A computer program product for reducing computational costs associated with predicting demand for a first financial product, the computer program product comprising a non-transitory computer readable medium comprising computer readable instructions, the instructions comprising instructions for:
receiving hypothetical customer profile data for a plurality of hypothetical customers;
receiving competing financial product data for a plurality of competing financial products, wherein the competing financial products comprise the first financial product and at least one other financial product that competes with the first financial product, and wherein the competing financial product data comprises at least a competing financial product, one or more financing types associated with each competing financial product, and one or more origination channels associated with each competing financial product;
storing hypothetical customer profile data in one or more network databases;
storing competing financial product data in one or more network databases;
storing a plurality of rules for how hypothetical customers make a financial product decision in one or more network databases;
identifying two or more segments for the competing financial products from the stored competing financial product data, wherein the segments comprise a first financial product segment, and wherein each of the segments comprises a combination of the following:
one of the competing financial products;
one of the one or more financing types associated with the one of the competing financial products; and
one of the one or more origination channels associated with the one of the competing financial products;
executing a dynamic cannibalization module, wherein the dynamic cannibalization module is configured to cause the one or more processing devices to:
establish a minimum cannibalization tolerance level;
pair the first financial product segment with one other segment of the segments, wherein the first segment comprises the first financial product;
determine a minimum price point for each of the first financial product segment and the other segment;
determine a maximum price point for each of the first financial product segment and the other segment;
calculate a first difference Δ₁, wherein the first difference Δ₁ is the difference between a first demand volume of the first financial product segment from when both of the first financial product segment and the other segment are at their maximum price points and a second demand volume of the first financial product segment from when both of the first financial product segment and the other segment are at their minimum price points;
calculate a second difference Δ₂, wherein the second difference Δ₂ is the difference in a third demand volume of the first financial product segment from when the first financial product segment is at its maximum price point and the other segment is at its minimum price point, and a fourth demand volume of the first financial product segment from when the first financial product segment is at its minimum price point and the other segment is at its maximum price point;
calculate a cannibalization percentage Cₚₑᵣ, wherein the cannibalization percentage Cₚₑᵣ is the difference between the first difference Δ₁ and the second difference Δ₂, divided by a baseline volume V_{base};
determine if the cannibalization percentage is equal to or greater than the minimum cannibalization tolerance level;
if the cannibalization percentage is equal to or greater than the minimum cannibalization tolerance level, then combine the first financial product segment and the other segment into a first segment group; and
repeat the steps “pair the first financial product segment . . . ” through “combine the first financial product segment and the other segment . . . ” for all other segments of the segments; and
determining an ideal price point for the first financial product segment based on the first segment group.

14. The computer program product of claim 13, further comprising:
determining a plurality of available price points for the first financial product segment;
selecting a first price point for the first financial product from the plurality of available price points;
determining a demand volume of the first financial product segment at the selected price point, wherein the demand volume of the first financial product segment is calculated based on an exhaustive algorithm that analyzes the demand volume of the first financial product segment for each combination of a plurality of price points for the one or more segments of the segment group;
storing the determined demand volume of the first financial product segment at the selected price point;
repeating steps from “select a first price point . . . ” to “store the calculated demand volume . . . ” for each price point of the plurality of available price points for the first financial product segment; and
determining an ideal price point for the first financial product segment based on the determined demand volume data.

15. The computer program product of claim 14, further comprising:
applying the ideal price point to the first financial product segment.

16. The computer program product of claim 13, further comprising:
monitoring one or more network databases for changes to the hypothetical customer profile data and the competing financial product data;
determining that one of the hypothetical customer profile data or the competing financial product data has changed; and
updating the one or more network databases associated with the hypothetical customer profile data or the competing financial product data with the changed data.

17. The computer program product of claim 13, wherein the first financial product is a loan refinancing product.

18. The computer program product of claim 13, wherein the first financial product is a purchase loan product.
